(19) United States
(12) Patent Application Publication
(10) Pub. No.: US 2026/0107317 A1
(43) Pub. Date: Apr. 16, 2026

(54) TERMINAL, RADIO COMMUNICATION METHOD, AND BASE STATION

(71) Applicant: NTT DOCOMO, INC., Tokyo (JP)

(72) Inventors: Naoya SHIBAIKE, Tokyo (JP); Yuki MATSUMURA, Tokyo (JP); Satoshi NAGATA, Tokyo (JP); Qiping PI, Beijing (CN); Jing WANG, Beijing (CN); Lan CHEN, Beijing (CN)

(73) Assignee: NTT DOCOMO, INC., Tokyo (JP)

(21) Appl. No.: 19/116,089

(22) PCT Filed: Sep. 29, 2022
(86) PCT No.: PCT/JP2022/036414

§ 371 Date: Mar. 27, 2025

(51) Int. Cl. H04W 74/0833; H04L 1/08

(52) U.S. Cl. CPC H04W 74/0833; H04L 1/08

(57) ABSTRACT

A terminal according to one aspect of the present disclosure includes a control section that determines a resource for each of a plurality of repetitions of a physical random access channel (PRACH), and a transmitting section that transmits the each of the plurality of repetitions using the plurality of resources. According to one aspect of the present disclosure, coverage of a random access procedure can be improved.

### TECHNICAL FIELD

The present disclosure relates to a terminal, a radio communication method, and a base station in next-generation mobile communication systems.

### BACKGROUND

In a Universal Mobile Telecommunications System (UMTS) network, the specifications of Long-Term Evolution (LTE) have been drafted for the purpose of further increasing high speed data rates, providing lower latency and so on (see Non-Patent Literature 1). In addition, for the purpose of further high capacity, advancement and the like of the LTE (Third Generation Partnership Project (3GPP (registered trademark) ) Release (Rel.) 8 and Rel. 9), the specifications of LTE-Advanced (3GPP Rel. 10 to Rel. 14) have been drafted.

Successor systems of LTE (for example, also referred to as “5th generation mobile communication system (5G), ” “5G+(plus),” “6th generation mobile communication system (6G), ” “New Radio (NR),” “3GPP Rel. 15 (or later versions),” and so on) are also under study.

### Citation List

### Non-Patent Literature

Non-Patent Literature 1:3GPP TS 36.300 V8.12.0 “Evolved Universal Terrestrial Radio Access (E-UTRA) and Evolved Universal Terrestrial Radio Access Network (E-UTRAN); Overall description; Stage 2 (Release 8),”April, 2010

### SUMMARY OF INVENTION

### Technical Problem

For future radio communication systems (for example, NR), improvements in coverage are under study.

However, a random access procedure for the improvements in coverage is not clear. Communication throughput may degrade unless such a random access procedure is clear.

Thus, an object of the present disclosure is to provide a terminal, a radio communication method and a base station that improve coverage of the random access procedure.

### Solution to Problem

A terminal according to one aspect of the present disclosure includes a control section that determines a resource for each of a plurality of repetitions of a physical random access channel (PRACH), and a transmitting section that transmits the each of the plurality of repetitions using the plurality of resources.

### Advantageous Effects of Invention

According to one aspect of the present disclosure, coverage of a random access procedure can be improved.

### BRIEF DESCRIPTION OF DRAWINGS

FIG. 1 illustrates an example of an RACH configuration information element.

FIG. 2 FIGS. 2A and 2B illustrate examples of associations of PRACH occasions and beams.

FIG. 3 illustrates an example of a feature combination configuration according to Embodiment #2-1.

FIG. 4 illustrates an example of RO/preamble determination according to Embodiment #2-1.

FIG. 5 illustrates an example of the RO/preamble determination according to Embodiment #2-2.

FIG. 6 illustrates an example of the feature combination configuration according to Embodiment #2-3.

FIG. 7 illustrates an example of the RO/preamble determination according to Embodiment #2-3.

FIG. 8 FIGS. 8A and 8B illustrate examples of the feature combination configurations according to Embodiment #2-4.

FIG. 9 illustrates an example of the association of a PRACH mask index field value and a PRACH mask index for each repetition.

FIG. 10 illustrates an example of a CFRA configuration.

FIG. 11 illustrates an example of a two-step CFRA configuration.

FIG. 12 illustrates an example of an SI request resource configuration.

FIG. 13 illustrates another example of the SI request resource configuration.

FIG. 14 illustrates an example of a beam failure recovery configuration.

FIG. 15 FIGS. 15A and 15B illustrate examples of ROs for a PRACH repetition.

FIG. 16 FIGS. 16A and 16B illustrate other examples of the ROs for the PRACH repetition.

FIG. 17 illustrates an example of an implicit RO resource determination.

FIG. 18 is a diagram illustrating an example of a schematic configuration of a radio communication system according to one embodiment.

FIG. 19 is a diagram illustrating an example of a configuration of a base station according to one embodiment.

FIG. 20 is a diagram illustrating an example of a configuration of a user terminal according to one embodiment.

FIG. 21 is a diagram illustrating an example of a hardware configuration of the base station and the user terminal according to one embodiment.

FIG. 22 is a diagram illustrating an example of a vehicle according to one embodiment.

### DESCRIPTION OF EMBODIMENTS

### TCI, Spatial Relation, QCL

For NR, control of reception processing (for example, at least one of reception, demapping, demodulation, and decoding) and transmission processing (for example, at least one of transmission, mapping, precoding, modulation, and coding), in the UE, of at least one of a signal and a channel (referred to as a signal/channel) based on a transmission configuration indication state (TCI state) is under study.

The TCI state may be a state applied to a downlink signal/channel. An equivalent of the TCI state applied to an uplink signal/channel may be expressed as spatial relation.

The TCI state is information related to quasi-co-location (QCL) of the signal/channel, and may be referred to as a spatial reception parameter, spatial relation information, or the like.

The TCI state may be configured for the UE for each channel or for each signal.

QCL is an indicator indicating statistical properties of the signal/channel. For example, when a certain signal/channel and another signal/channel are in a relationship of QCL, it may be indicated that it is assumable that at least one of Doppler shift, a Doppler spread, an average delay, a delay spread, and a spatial parameter (for example, a spatial reception parameter (spatial Rx parameter) ) is the same (the relationship of QCL is satisfied in at least one of these) between such a plurality of different signals/channels.

Note that the spatial reception parameter may correspond to a receive beam of the UE (for example, a receive analog beam), and the beam may be identified based on spatial QCL. The QCL (or at least one element in the relationship of QCL) in the present disclosure may be interpreted as sQCL (spatial QCL).

For the QCL, a plurality of types (QCL types) may be defined. For example, four QCL types A to D may be provided, which have different parameter(s) (or parameter set(s)) that can be assumed to be the same, and such parameter(s) (which may be referred to as QCL parameter(s)) are described below:
QCL type A (QCL-A): Doppler shift, Doppler spread, average delay, and delay spread
QCL type B (QCL-B): Doppler shift and Doppler spread
QCL type C (QCL-C): Doppler shift and average delay
QCL type D (QCL-D): Spatial reception parameter

A case that the UE assumes that a certain control resource set (CORESET), channel, or reference signal is in a relationship of specific QCL (for example, QCL type D) with another CORESET, channel, or reference signal may be referred to as QCL assumption.

The UE may determine at least one of a transmit beam (Tx beam) and a receive beam (Rx beam) of the signal/channel, based on the TCI state or the QCL assumption of the signal/channel.

The TCI state may be, for example, information related to QCL between a channel as a target (in other words, a reference signal (RS) for the channel) and another signal (for example, another RS). The TCI state may be configured (indicated) by higher layer signaling or physical layer signaling, or a combination of these.

The physical layer signaling may be, for example, downlink control information (DCI).

A channel for which the TCI state or spatial relation is configured (specified) may be, for example, at least one of a downlink shared channel (Physical Downlink Shared Channel (PDSCH) ), a downlink control channel (Physical Downlink Control Channel (PDCCH) ), an uplink shared channel (Physical Uplink Shared Channel (PUSCH) ), and an uplink control channel (Physical Uplink Control Channel (PUCCH) ).

The RS to have a QCL relationship with the channel may be, for example, at least one of a synchronization signal block (SSB), a channel state information reference signal (CSI-RS), a reference signal for measurement (Sounding Reference Signal (SRS) ), a CSI-RS for tracking (also referred to as a Tracking Reference Signal (TRS) ), and a reference signal for QCL detection (also referred to as a QRS).

The SSB is a signal block including at least one of a primary synchronization signal (PSS), a secondary synchronization signal (SSS), and a broadcast channel (Physical Broadcast Channel (PBCH) ). The SSB may be referred to as an SS/PBCH block.

An RS of QCL type X in a TCI state may mean an RS in a relationship of QCL type X with (a DMRS of) a certain channel/signal, and this RS may be referred to as a QCL source of QCL type X in the TCI state.

### Initial Access Procedure

In the initial access procedure, the UE (in an RRC_IDLE mode) performs a reception of the SS/PBCH block (SSB), a transmission of Msg.1 (PRACH/random access preamble/preamble), a reception of Msg.2 (PDCCH, PDSCH including a random access response (RAR) ), a transmission of Msg.3 (PUSCH scheduled by an RAR UL grant) and a reception of Msg.4 (PDCCH, PDSCH including a UE contention resolution identity). After that, when the base station (network) transmits an ACK for Msg.4 from the UE, an RRC connection is established (RRC_CONNECTED mode).

The reception of the SSB includes a PSS detection, an SSS detection, a PBCH-DMRS detection and a PBCH reception. The PSS detection involves a partial detection of a physical cell ID (PCI), detection (synchronization) of an OFDM symbol timing and a (coarse) frequency synchronization. The SSS detection includes the detection of the physical cell ID. The PBCH-DMRS detection includes detection of (a part of) an SSB index within a half radio frame (5 ms). The PBCH reception includes detection of a system frame number (SFN) and a radio frame timing (SSB index), a reception of configuration information for a reception of remaining minimum system information (RMSI, SIB1) and a recognition of whether the UE is able to camp in that cell (carrier) or not.

The SSB has a bandwidth of 20 RBs and times of four symbols. A transmission periodicity of the SSB can be configured as {5, 10, 20, 40, 80, 160} ms. In a half frame, a plurality of symbol positions of the SSB are specified based on a frequency range (FR1, FR2).

The PBCH has a 56-bit payload. N repetitions of the PBCH are transmitted within a periodicity of 80 ms. N depends on the transmission periodicity of the SSB.

System information consists of an MIB carried by the PBCH, the RMSI (SIB1) and other system information (OSI). SIB1 includes information for performing an RACH configuration and an RACH procedure. The relationship of a resource of the time/frequency between the SSB and a PDCCH monitoring resource for SIB1 is configured by the PBCH.

The base station that uses a beam correspondence transmits a plurality of SSBs each using a plurality of beams for each SSB transmission periodicity. The plurality of SSBs each includes a plurality of SSB indices. The UE that detects one SSB transmits the PRACH in an RACH occasion associated with that SSB index and receives the RAR in an RAR window.

### Beam and Coverage

In a high frequency band, unless beam forming is applied to a synchronization signal/reference signal, coverage becomes narrow, and it is difficult for the UE to identify the base station. On the other hand, applying the beam forming to the synchronization signal/reference signal in order to secure coverage causes a strong signal to be delivered in a specific direction, but makes it more difficult for signals to be delivered in directions other than that direction. In the base station before the UE is connected, assuming that a direction in which the UE exists is unknown, transmission of the synchronization signal/reference signal using a beam only in an appropriate direction fails. A method in which the base station transmits a plurality of synchronization signals/reference signals having respective beams in different directions, and recognizes which beam is identified by the UE is conceivable. When thin (narrow) beams are used for the coverage, many synchronization signals/reference signals are required to be transmitted, and thus overhead may increase, and frequency use efficiency may be reduced.

Using a thick (wide) beam in order to suppress overhead by reducing the number of beams (synchronization signals/reference signals) narrows coverage.

In future radio communication systems (for example, 6G), it is conceivable that use of frequency bands, such as millimeter waves and terahertz waves, advances further. It is conceivable that communication services are provided by developing a cell area/coverage by using multiple thin beams.

Expansion of the area using existing FR2 and use of a frequency band higher than existing FR2 are conceivable. In addition to multiple TRPs, reconfigurable intelligent surface (RIS), and the like, improvement in beam management is preferable for achieving these.

Coverage enhancement including PRACH enhancement for frequency range (FR) 2 is under study. For example, PRACH repetition using the same beam or a plurality of different beams is under study. This PRACH enhancement may be applied to a 4-step RACH or to FR1.

The PRACH enhancement may be applied to a short PRACH format, or may be applied to another format.

### PRACH

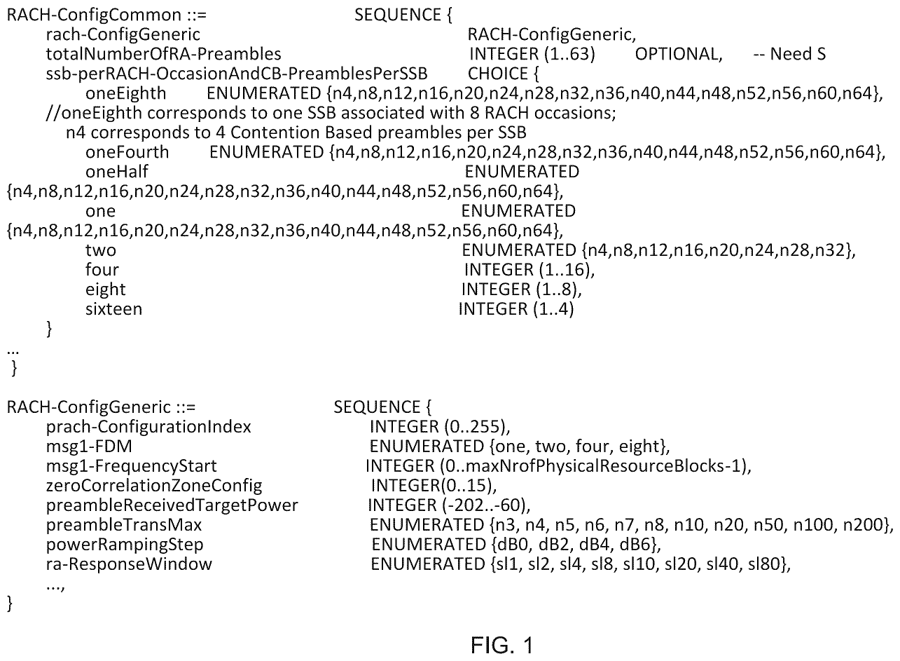

As shown in FIG. 1, common RACH configuration (RACH-ConfigCommon) may include generic RACH configuration (rach-ConfigGeneric), a total number of RA preambles (totalNumberOfRA-Preambles), and an SSB for each RACH occasion and contention-based (CB) preambles for each SSB (ssb-perRACH-OccasionAndCB-PreamblesPerSSB). rach-ConfigGeneric may include a PRACH configuration index (prach-ConfigurationIndex) and message 1 FDM (msg1-FDM, the number of PRACH occasions FDMed in one time instance). ssb-perRACH-OccasionAndCB-PreamblesPerSSB may include, for the number of SSBs for each RACH occasion ⅛ (oneEighth, a case that one SSB is associated with 8 RACH occasions), the number of CB preambles for each SSB.

For a type 1 random access procedure (4-step random access procedure, message 1/2/3/4), the number N of SS/PBCH blocks associated with one PRACH occasion and the number R of CB preambles for each valid PRACH occasion or for each SS/PBCH block may be applied for the UE by ssb-perRACH-OccasionAndCB-PreamblesPerSSB.

For the type 1 random access procedure or for a type 2 random access procedure (2-step random access procedure, message A/B) accompanied by PRACH occasion configuration independent of the type 1 random access procedure, if N<1, one SS/PBCH block is mapped to 1/N consecutive valid RACH occasions, and R CB preambles accompanied by consecutive indices associated with an SS/PBCH block index for each valid PRACH occasion start from preamble index 0. If N≥1, R CB preambles accompanied by consecutive indices associated with SS/PBCH block index n (0≤n <-N-1) for each valid PRACH occasion start from preamble index n * N_preamble\hat{ } total/N. Here, N_preamble\hat{ } total is given by totalNumberOfRA-Preambles for the type 1 random access procedure, and is given by msgA-TotalNumberOfRA-Preambles for the type 2 random access procedure accompanied by the PRACH occasion configuration independent of the type 1 random access procedure. N_preamble\hat{ } total is a multiple of N.

An association period, starting from frame 0, for mapping SS/PBCH blocks to PRACH occasions is a minimum value in a set determined by a PRACH configuration period in accordance with a relationship (relationship defined in specifications) between a PRACH configuration period and an association period (the number of PRACH configuration periods) so that N_{Tx}^{SSB} SS/PBCH block indices are mapped to PRACH occasions at least one time in the association period. Here, the UE obtains N_{Tx}^{SSB} from values of SSB positions in a burst (ssb-PositionsInBurst) in SIB 1 or in common serving cell configuration (ServingCellConfigCommon). If a set of PRACH occasions or PRACH preambles not mapped to N_{Tx}^{SSB} SS/PBCH block indices is present after an integer number of cycles of mapping from SS/PBCH block indices to PRACH occasions in the association period, none of the SS/PBCH block indices is mapped to the set of PRACH occasions or PRACH preambles. An association pattern period includes one or more association periods, and is determined so that a pattern between PRACH occasions and SS/PBCH block indices repeats every 160 ms at most. If a PRACH occasion not associated with SS/PBCH block indices after an integer number of association periods is present, the PRACH occasion is not used for a PRACH.

In the case of a PRACH transmission triggered by a higher layer (PRACH transmission not triggered by a PDCCH order), if an ssb-ResourceList is provided, a PRACH mask index is indicated by an ra-ssb-OccasionMaskIndex. The ra-ssb-OccasionMaskIndex indicates that PRACH occasion for the PRACH transmission in which the PRACH occasion is associated with a selected SS/PBCH block index.

A dedicated RACH configuration (RACH-ConfigDedicated) may include a CFRA configuration (CFRA) or a two-step CFRA configuration (CFRA-TwoStep). The CFRA indicates parameters for the CFRA to a given target cell. If this field and the CFRA-TwoStep do not exist, the UE performs a CBRA. The CFRA-TwoStep indicates parameters for a contention-free 2-step random access type to the given target cell. The CFRA and the CFRA-TwoStep may include an SSB resource list (ssb-ResourceList) and a PRACH mask index configuration (ra-SSB-OccasionMaskIndex). The ra-SSB-OccasionMaskIndex indicates the PRACH mask index that is explicitly notified for an RA resource selection. That mask is valid for all SSB resources that are notified in the SSB-ResourceList.

The PRACH occasion is consecutively mapped for each corresponding SS/PBCH block index. An indexing of the PRACH occasion that is indicated by a PRACH mask index value is reset for each SS/PBCH block index and for each mapping cycle of consecutive PRACH occasions. The UE selects the PRACH occasion that is indicated by the PRACH mask index value for a indicated SS/PBCH block index in the first available mapping cycle for the PRACH transmission.

For a indicated preamble index, the order of the PRACH occasions is as follows.
First, an increasing order of a frequency resource index for the PRACH occasion that is frequency-multiplexed.
Second, an increasing order of a time resource index for the PRACH occasion that is time-multiplexed in a PRACH slot.
Third, an ascending order of an index of the PRACH slot.

For the PRACH transmission triggered in response to a request from the higher layer, if a csirs-ResourceList is provided, a value of an ra-OccasionList indicates a list of the PRACH occasion for the PRACH transmission, and the PRACH occasion is associated with a selected CSI-RS index indicated by the csi-RS. The indexing of the PRACH occasion that is indicated by the ra-OccasionList is reset for each association pattern period.

The association periods are {1, 2, 4, 8, 16}, {1, 2, 4, 8}, {1, 2, 4}, {1, 2} and {1} for the PRACH configuration periods 10, 20, 40, 80 and 160 [msec], respectively.

A feature combination preamble configuration (FeatureCombinationPreambles) associates a set of preambles with a feature combination. When performing random access using preambles in the FeatureCombinationPreambles, the UE applies the field in that FeatureCombinationPreambles. The FeatureCombinationPreambles include a feature combination configuration (FeatureCombination) and a shared RO subset configuration (ssb-SharedRO-MaskIndex). The FeatureCombination indicates a feature or a combination of features that is associated with a set of random access resources. The ssb-SharedRO-MaskIndex indicates a subset of ROs in which the preamble is assigned for that feature combination. If there is more than one RO per SSB, this field is configured.

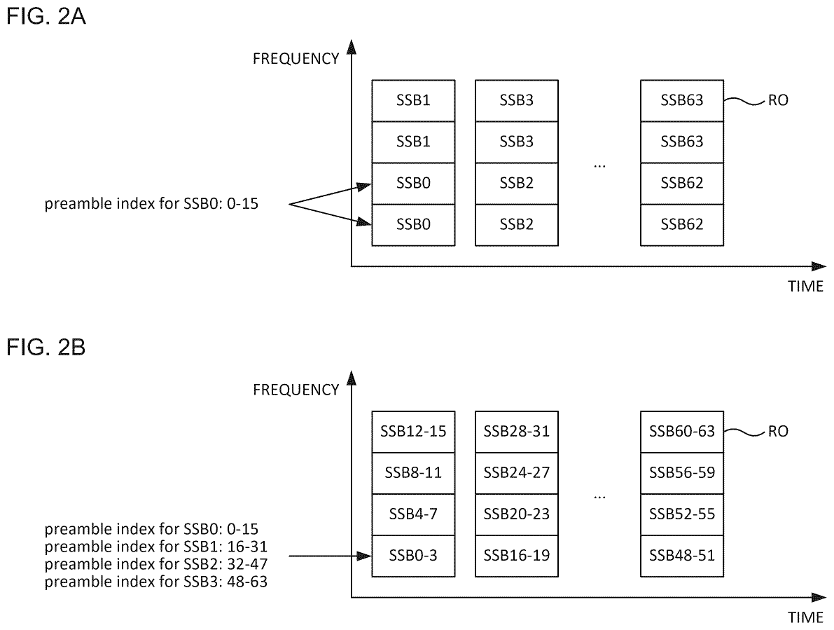

FIG. 2A is an example of an association of the PRACH occasion (RACH occasion (RO) ) and the beam (SSB/CSI-RS) based on a higher layer parameter, ssb-perRACH-OccasionAndCB-PreamblesPerSSB (mapping 1). In the case where the ssb-perRACH-OccasionAndCB-PreamblesPerSSB indicates oneHalf, n16 (N=1/2, R=16), and an msg1-FDM is four, then four ROs are FDMed in one single time instance, and one SSB is mapped to two ROS. Two ROs are associated with 15 from the preamble index 0, and 15 is associated with an SS0B from the preamble index 0. As such, if N<1, one SSB is mapped to a plurality of ROs. This increases a capacity of the RO per beam.

FIG. 2B is another example of an association of the RO and the beam based on the higher layer parameter, ssb-perRACH-OccasionAndCB-PreamblesPerSSB (mapping 2). In the case where the ssb-perRACH-OccasionAndCB-PreamblesPerSSB indicates n4, n16 (N=4, R=16), the msg1-FDM is four, and N_preamble\hat{ } total is 64, then four ROs are FDMed in one single time instance, and four SSBs are mapped to one RO. One RO is associated with 3 from SSB0. SSB0 is associated with 15 from the preamble index 0, SSB1 is associated with 31 from the preamble index 15, SSB2 is associated with 47 from the preamble index 32, and SSB3 is associated with 63 from the preamble index 48. As such, a same RO is associated with different SS/PBCH blockindices, and different preambles use the different SS/PBCH block indices. The base station can distinguish the associated SS/PBCH block index by the PRACH it receives.

The random access preamble can only be transmitted at a time resource specified in a random access configuration of the specification and depends on whether the frequency range is FR1 or FR2 as well as a spectrum type (paired /ectrum/ supplementary uplink (SUL) /unpaired spectrum). The PRACH configuration index is given by the higher layer parameter, prach-ConfigurationIndex, or, if configured, by an msgA-PRACH-ConfigurationIndex. In the specification, it is associated for each value of the PRACH configuration index with at least one of a preamble format, x and y for n_f (frame number) mod x=y, a subframe number, a starting symbol, the number of PRACH slots in the subframe, the number of time domain PRACH occasions in the PRACH slot, N_t\hat{ } RA, slot, and a PRACH duration, N_dur\hat{ } RA.

### A type of the rach procedure triggered by whether prach repetition can be applied to a scenario or by different purposes varies. The type of RACH procedure may be at least one of the following.

A contention-free random access (CFRA), a PDCCH ordered RA (RA initiated by the PDCCH order), the CFRA for a beam failure recovery (BFR), the CFRA for a system information (SI) request, the CFRA for a reconfiguration involving synchronization (reconfiguration with sync), etc.
A contention-based random access (CBRA), the RA triggered by an MAC entity, the RA triggered by an RRC involving an event, the CBRA for the BFR, etc.
A four-step RACH.
A two-step RACH.

### PDCCH Order

A DCI format 1_0 includes an identifier field of a DCI format, a bit field that is constantly set to 1 and a frequency domain resource assignment field. If a cyclic redundancy check (CRC) of the DCI format 1_0 is scrambled by a C-RNTI, and all frequency domain resource assignment fields are 1, then the DCI format 1_0 is for the random access procedure initiated by the PDCCH order, and the other fields are the random access preamble, a UL/supplementary Uplink (SUL) indicator, an SS/PBCH index (SSB index), the PRACH mask index and reserved bits (12 bits).

In the case of the PRACH transmission triggered by the PDCCH order, if a value of a random access preamble index field is not zero, a PRACH mask index field indicates the PRACH occasion of the PRACH transmission in which the PRACH occasion is associated with the SS/PBCH block index indicated by an SS/PBCH block index field of the PDCCH order.

### Random Access Procedure for the Mac Entity

The random access procedure is initiated by the PDCCH order, the MAC entity itself or the RRC for the event that conforms to the specification. In the MAC entity, there is only one random access procedure in progress at any given time. The random access procedure of an SCell is initiated only by the PDCCH order involving an ra-PreambleIndex that is different from 0b000000.

If the random access procedure is initiated on a serving cell, the MAC entity performs the following.
If the random access procedure is initiated by the PDCCH order, and the ra-PreambleIndex explicitly provided by the PDCCH is not 0b000000, or if the random access procedure is initiated for a reconfiguration involving synchronization, and a four-step RA type contention-free random access resource is explicitly provided by the rach-ConfigDedicated for a BWP selected for the random access procedure, an RA_TYPE is configured to a 4-stepRA.

If a selected RA_TYPE is configured to the 4-stepRA, the MAC entity performs the following.
If the ra-PreambleIndex is explicitly provided from the PDCCH, and the ra-PreambleIndex is not 0b000000, a PREAMBLE_INDEX is set to a notified ra-PreambleIndex, and the SSB notified by the PDCCH is selected.
If the SSB is selected as described above, the PRACH occasion that is available next is determined from the PRACH occasion corresponding to the SSB that is approved and selected by the restriction given by the ra-ssb-OccasionMaskIndex (the MAC entity selects the PRACH occasion randomly with equal probability from among consecutive PRACH occasions in response to a selected SSB in accordance with the specification. The MAC entity may consider the possibility of the occurrence of a measurement gap when determining the PRACH occasion that is available next and corresponds to the selected SSB).

### Time Between a PDCCH Order Reception and the PRACH Transmission

If the random access procedure is initiated by the PDCCH order, the UE, if required by the higher layer, transmits the PRACH in the selected PRACH occasion in the case of a time between a last symbol of the PDCCH order reception and a first symbol of the PRACH transmission being

N_ (T, 2)+Δ_BWPSwitching+Δ_Delay+T_switch [msec] or longer (time condition), as described in the specification, where N_(T, 2) is the duration of an N_2 symbol corresponding to a PUSCH preparation time of UE processing capability 1. μ is assumed to correspond to a minimum SCS configuration between a subcarrier spacing (SCS) configuration of the PDCCH order and the corresponding SCS configuration of the PRACH transmission. If an active UL BWP does not change, Δ_BWPSwitching=0, otherwise, Δ_BWPSwitching is defined in the specification. For FR1, Δ_delay=0.5 msec, and for FR2, Δ_delay=0.25 msec. A T_switch is a switching gap duration as defined in the specification.

### Conditions for Valid/Invalid of the Prach Occasion (Validity Conditions)

For the paired spectrum (FDD) or an SUL band, all PRACH occasions are valid. For the unpaired spectrum (TDD), the PRACH occasion may be in accordance with the following provisions 1 and 2.

### Provision 1

When the UE is not provided with a Tdd-ul-dl-ConfigurationCommon, if the PRACH occasion in the PRACH slot does not precede the SS/PBCH block in the PRACH slot and starts at least N_gap symbols after a last SS/PBCH block reception symbol, then the PRACH occasion is valid, where the N_gap is specified in the specification. If a channelAccessMode=semistatic is provided, it does not overlap with a set of consecutive symbols before the start of a next channel occupation time that the UE does not transmit. A candidate SS/PBCH block index of the SS/PBCH block corresponds to the SS/PBCH block index provided by the ssb-PositionsInBurst in SIB1 or in the ServingCellConfigCommon.

### Provision 2

When the UE is provided with the tdd-UL-DL-ConfigurationCommon, the PRACH occasion in the PRACH slot is valid in the following cases:
That PRACH occasion is in a UL symbol; or
That PRACH occasion does not precede the SS/PBCH block in the PRACH slot and starts at least N_gap symbols after a last DL symbol as well as at least N_gap symbols after a last SS/PBCH block symbol, where the N_gap is specified in the specification. If the channelAccessMode=semistatic is provided, that PRACH occasion does not overlap with the set of consecutive symbols before the start of the next channel occupation time, during which any transmission must not be performed, as described in the specification. A candidate SS/PBCH block index of the SS/PBCH block corresponds to the SS/PBCH block index provided by the ssb-PositionsInBurst in SIB1 or in the ServingCellConfigCommon, as described in the specification.

### Problems

The following several problems can be considered.
[Problem 1] The relationship between an index/number of the PRACH repetition and the RO is not clear.
[Problem 2] The relationship between the index/number of the PRACH repetition and the index/number of the preamble is not clear.
[Problem 3] The PRACH repetition based on the PDCCH order is not clear.
[Problem 4] A method of implicit determination of the RO for a plurality of PRACH repetitions is not clear.

If such problems are not solved, communication quality, etc., may be degraded.

Therefore, the inventors of the present invention came up with the idea of the operation of the PRACH repetition.

Embodiments according to the present disclosure will be described in detail with reference to the drawings as follows. Note that the embodiments (for example, cases) to be described below may each be employed individually, or at least two of those may be employed in combination.

In the Present Disclosure, “A/B” and “at least one of A and B” may be used interchangeably. In the present disclosure, “A/B/C” may mean “at least one of A, B, and C.”

In the Present Disclosure, Activate, Deactivate, Indicate, select, configure, update, determine, and the like may be used interchangeably. In the present disclosure, “support,” “control,” “controllable,” “operate,” “operable,” and the like may be used interchangeably.

In the present disclosure, radio resource control (RRC), an RRC parameter, an RRC message, a higher layer parameter, an information element (IE), a configuration, and the like may be used interchangeably. In the present disclosure, a Medium Access Control control element (MAC Control Element (CE) ), an update command, an activation/deactivation command, and the like may be used interchangeably.

In the present disclosure, the higher layer signaling may be, for example, any one or combinations of Radio Resource Control (RRC) signaling, Medium Access Control (MAC) signaling, broadcast information, and the like.

In the present disclosure, the MAC signaling may use, for example, a MAC control element (MAC CE), a MAC Protocol Data Unit (PDU), or the like. The broadcast information may be, for example, a master information block (MIB), a system information block (SIB), minimum system information (Remaining Minimum System Information (RMSI) ), other system information (OSI), or the like.

In the present disclosure, the physical layer signaling may be, for example, downlink control information (DCI), uplink control information (UCI), or the like.

In the present disclosure, an index, an identifier (ID), an indicator, a resource ID, and the like may be used interchangeably. In the present disclosure, a sequence, a list, a set, a group, a cluster, a subset, and the like may be used interchangeably.

In the present disclosure, a panel, a panel group, a beam, a beam group, a precoder, an Uplink (UL) transmission entity, a transmission/reception point (TRP), a base station, spatial relation information (SRI), a spatial relation, an SRS resource indicator (SRI), a control resource set (CORESET), a Physical Downlink Shared Channel (PDSCH), a codeword (CW), a transport block (TB), a reference signal (RS), an antenna port (for example, a demodulation reference signal (DMRS) port), an antenna port group (for example, a DMRS port group), a group (for example, a spatial relation group, a code division multiplexing (CDM) group, a reference signal group, a CORESET group, a Physical Uplink Control Channel (PUCCH) group, a PUCCH resource group), a resource (for example, a reference signal resource, an SRS resource), a resource set (for example, a reference signal resource set), a CORESET pool, a downlink Transmission Configuration Indication state (TCI state) (DL TCI state), an uplink TCI state (UL TCI state), a unified TCI state, a common TCI state, quasi-co-location (QCL), QCL assumption, and the like may be used interchangeably.

In the present disclosure, “having the ability of.” “and upporting reporting the ability of.” may be used interchangeably.

In the Present Disclosure, Index/indicator of the SSB/CSI-RS, beam index, TCI state, spatial domain transmission filter and spatial domain reception filter may be used interchangeably.

In the present disclosure, RAR window, ra-ResponseWindow, time window, RAR timer and operation period of a timer may be used interchangeably. In the present disclosure, contention resolution window, contention window, contention resolution timer, ra-ContentionResolutionTimer and operation period of the contention resolution timer may be used interchangeably. In the present disclosure, contention resolution identity, contention resolution ID and UE contention resolution identity may be used interchangeably.

In the present disclosure, port, antenna port, DMRS port and DMRS antenna port may be used interchangeably. In the present disclosure, the port being QCLed with a reception of the RS and the port using the same spatial domain (transmission/reception) filter as the reception of the RS may be used interchangeably.

In the present disclosure, the DCI (format) /PDCCH (candidate) involving the CRC scrambled by a specific RNTI, the DCI (format) /PDCCH (candidate) using a specific RNTI and the DCI (format) /PDCCH (candidate) that is monitored using a specific RNTI may be used interchangeably.

### Radio Communication Method

In each embodiment, RACH resource, RA resource, PRACH preamble, occasion, RACH occasion (RO), PRACH occasion, repetition resource, repetition configuration resource, resource configured for the RO/repetition, time instance and frequency instance, time resource and frequency resource, resource of the RO/preamble as well as repetition may be used interchangeably. In each embodiment, period, cycle, frame, subframe, slot, symbol, occasion and RO may be used interchangeably.

In each embodiment, PDCCH order, PDCCH order DCI, DCI format 1_0 and message (Msg) 0 may be used interchangeably. In each embodiment, PRACH, preamble, PRACH preamble, sequence, preamble format and Msg1 may be used interchangeably.

In each embodiment, RAR, DCI that schedules the RAR (PDCCH), PDSCH involving a UE contention resolution ID and DCI that schedules the PDSCH involving the UE contention resolution ID may be used interchangeably.

In each embodiment, beam, SSB, SSB index, CSI-RS, CSI-RS resource, CSI-RS resource index and RS may be used interchangeably.

In each embodiment, random access (RA) procedure, CFRA/CBRA, four-step RACH/two-step RACH, random access procedure of a specific type, random access procedure using a specific PRACH format, random access procedure initiated by the PDCCH order, random access procedure that is not initiated by the PDCCH order and random access procedure initiated by the higher layer may be used interchangeably.

### Embodiment #1

This embodiment relates to problem 1.

Separate ROs for the indices/numbers of different PRACH repetitions may be supported. Separate RACH configurations or RACH configuration indices for the indices/numbers of the different PRACH repetitions may be supported.

### Example 1

A plurality of additional PRACH configuration indices may be configured/indicated for a different repetition index. When the UE attempts to transmit the plurality of PRACH repetitions, the RO for a certain repetition index may be configured by a corresponding PRACH configuration index.

### Example 2

A new RACH configuration table involving one entry indicating one or X (X≥2) PRACH configuration indices may be specified. Each of the X PRACH configuration indices in a row may correspond to one repetition index.

According to This Embodiment, the Ue Can Properly Determine the RO for the index/number of the PRACH repetition. The Separate ROs for the indices/numbers of the PRACH repetitions are beneficial for the identification of the plurality of repetitions at the base station and enables soft combining at the base station.

### Embodiment #2

This embodiment relates to problem 2.

### Embodiment #2-1

Separate preamble resources for the indices/numbers of different PRACH repetitions may be supported. The preamble resource may be in accordance with at least one of the following several options/variations.

### Option 1

Explicit indication/configuration of a plurality of preamble indices for the indices/numbers of each of the repetitions may be supported for the plurality of preamble indices in a preamble index group for the plurality of PRACH repetitions.

### Example

The plurality of preamble indices for a first repetition, a second repetition, etc. (the preamble index specific to the repetition index) may be explicitly indicated/configured. For example, preamble indices #0-#7 may be indicated/configured for the first repetition, and preamble indices #8-#15 for the second repetition.

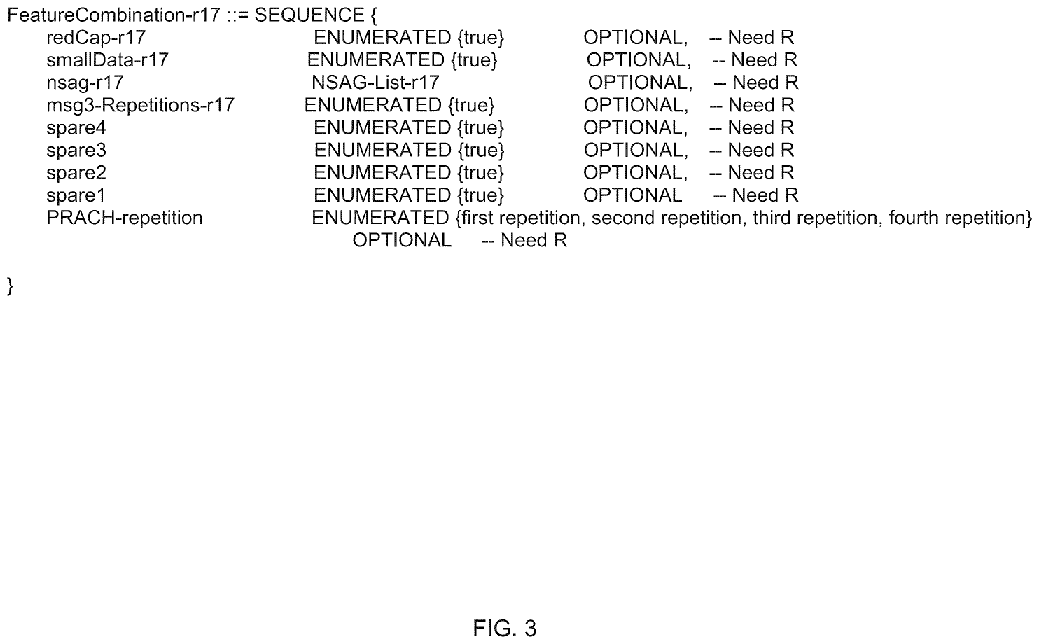

In the example of FIG. 3, the FeatureCombination includes a parameter indicating either one of the plurality of repetitions of the PRACH (for example, the first repetition, the second repetition, the third repetition and the fourth repetition) (for example, a PRACH-repetition). The FeatureCombination may be an enhancement of FeatureCombination-r17 or a new FeatureCombination (for example, FeatureCombination-r18).

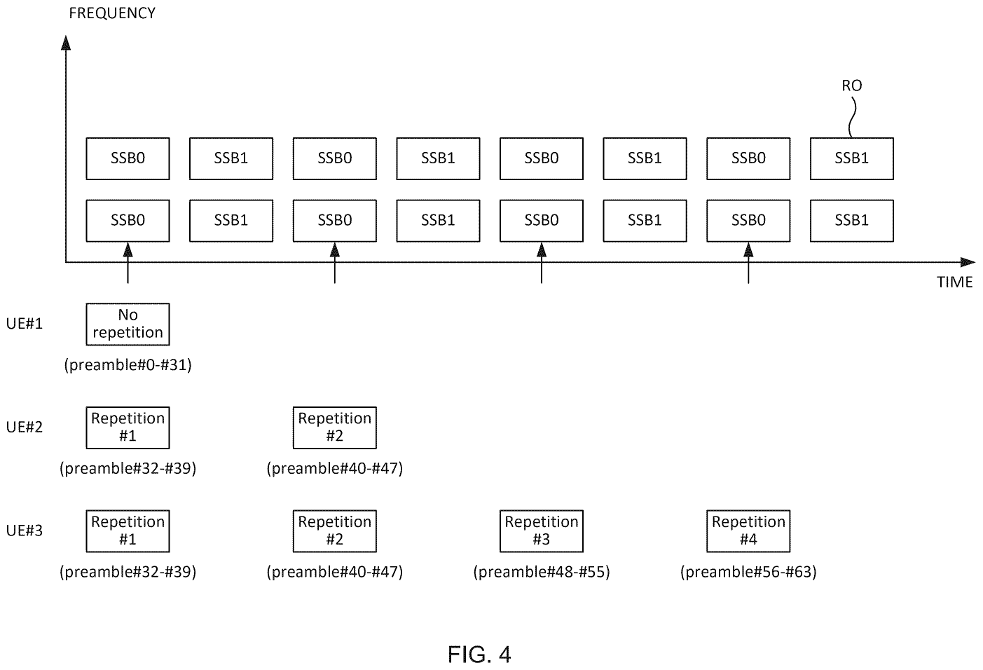

In the example of FIG. 4, the PRACH without repetition is configured for UE #1, two repetitions of the PRACH for UE #2, and four repetitions of the PRACH for UE #3. If SSB0 is selected, UE #1 uses preamble indices 0-31 for the PRACH without repetition. If SSB0 is selected, UE #2 uses preamble indices 32-39 for repetition index 1and preamble indices 40-47 for repetition index 2. If SSBO is selected, UE #3 uses preamble indices 32-39 for repetition index 1, preamble indices 40-47 for repetition index 2, preamble indices 48-55 for repetition index 3 and preamble indices 56-63 for repetition index 4.

### Option 2

The plurality of preamble indices in the preamble index group for the plurality of PRACH repetitions may be distributed for a plurality of different repetition indices based on a rule. For example, the plurality of preamble indices in the preamble index group for the plurality of PRACH repetitions may be equally divided into M groups, with each group mapped to the index/number of each repetition.

M may be the maximum number of the PRACH repetitions to be supported.

### Variation

There may be no explicit indication/configuration for the plurality of PRACH repetitions.

### Example

If the number of preamble index per SSB and per valid RO is R, a rule for the distribution of preamble index/indices may be used. For example, M preamble indices from the first/last may be for the PRACH without repetition, and the remaining (R-M) preamble index/indices may be equally distributed for the index/number of different repetitions. For example, M preamble index/indices from the first/last may be for the first transmission (first repetition) of the PRACH transmission, and the remaining (R-M) preamble index/indices may be equally distributed for the index/number of the different repetitions for a subsequent PRACH repetition. The value of M or M/R may be a fixed value defined in the specification or may be configured/indicated by the base station via an SIB/RRC IE/DCI/MAC CE.

### Embodiment #2-2

The relationship between the plurality of indices of the preamble/RO for the plurality of PRACH repetitions may be defined in the specification or may be indicated by the base station.

When different multiple indices of the preamble/RO are used for the plurality of PRACH repetitions with different indices/numbers, the index of the preamble/RO for a later/earlier repetition may include a fixed gap for the index of the preamble/RO for an earlier/later repetition.

In the case where the UE selects preamble index #m1 for a first PRACH repetition, when a second PRACH repetition is about to be transmitted, that UE may select preamble index #(m1+X0) for the second PRACH repetition, and when an (n+1) th PRACH repetition is about to be transmitted, that UE may select preamble index #(m1+n*X0) for the (n+1) th PRACH repetition, where (n+1) may be the maximum number of the PRACH repetitions to be supported or smaller.

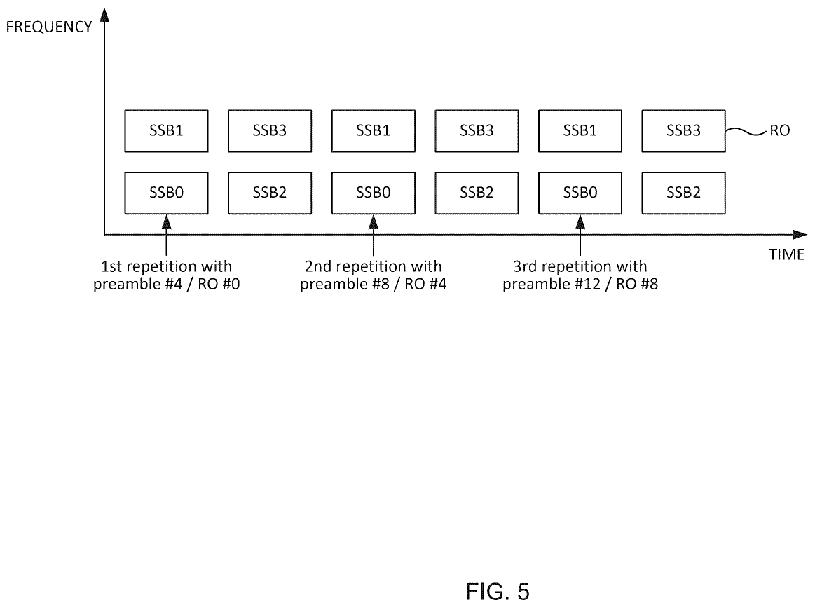

In the example of FIG. 5, SSB0 is associated with ROs #0, #4, #8, . . . RO #0 is mapped to preamble #4, RO #4 to preamble #12, and RO #8 to preamble #20. In this example, the UE that selects SSB0 may select RO #0 and preamble #4 for the first PRACH repetition, RO #4 and preamble #8 for the second PRACH repetition, RO #8 and preamble #12 for a third PRACH repetition.

### Embodiment #2-3

The separate preamble resources for different numbers of the PRACH repetitions (total number of times, total numbers) may be supported. The preamble resource may be in accordance with at least one of the following several options/variations.

### Option 1

Explicit Indication/configuration of the Plurality of preamble indices for the different numbers of the PRACH repetitions may be supported for the plurality of preamble indices in the preamble index group for the plurality of PRACH repetitions.

### Example

The preamble index for the PRACH with two repetitions, the preamble index for the PRACH with four repetitions, etc.

(preamble index specific to the number of repetitions) may be explicitly indicated/configured. For example, preamble indices #0-#7 may be indicated/configured for the PRACH with two repetitions, and preamble indices #8-#15 for the PRACH with four repetitions.

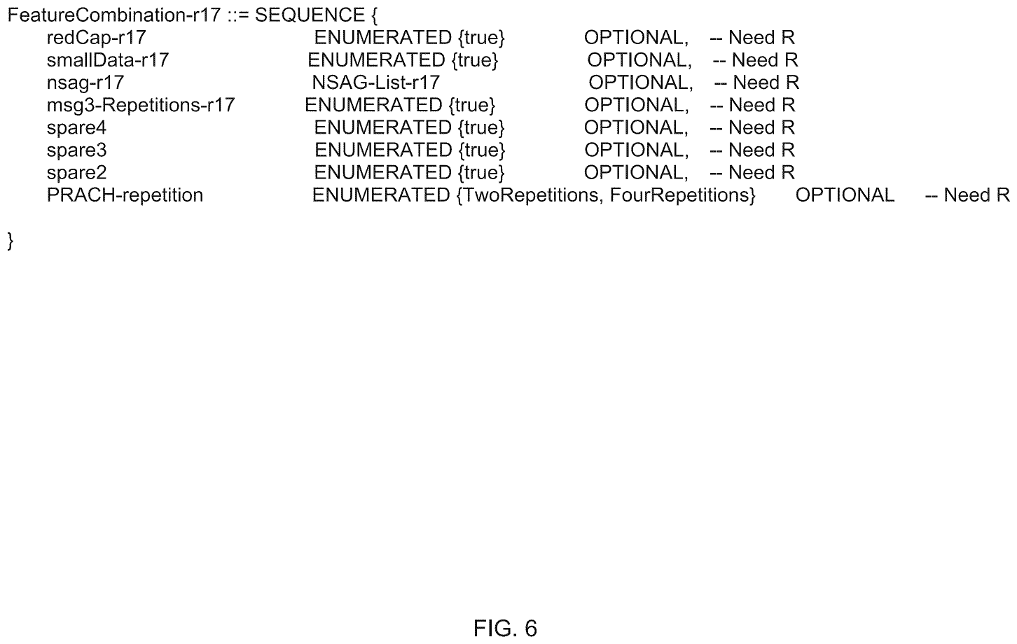

In the example of FIG. 6, a FeatureCombination-includes a parameter indicating any one of the numbers of the PRACH repetitions (TwoRepetitions, FourRepetitions) (for example, the PRACH-repetition). The FeatureCombination may be the enhancement of FeatureCombination-r17 or the new FeatureCombination (for example, FeatureCombination-r18).

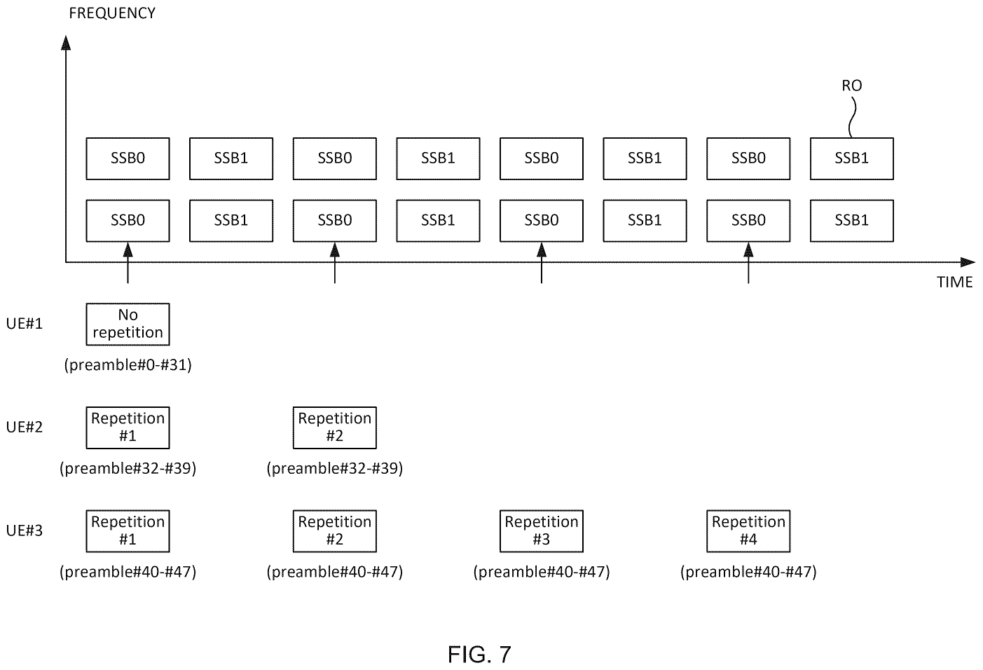

In the example of FIG. 7, the PRACH without repetition is configured for UE #1, two repetitions of the PRACH for UE #2, and four repetitions of the PRACH for UE #3. If UE #1 selects SSB0 the UE #1 uses preamble indices 0-31 for the PRACH without repetition. If UE #2 selects SSB0, the UE #2 uses preamble indices 32-39 for (each repetition of) the two repetitions of the PRACH. If UE #3 selects SSB0, the UE #3 uses preamble indices 40-47 for (each repetition of) the four repetitions of the PRACH.

### Option 2

The plurality of preamble indices in the preamble index group for the plurality of PRACH repetitions may be distributed for the plurality of different repetition indices based on the rule. For example, the plurality of preamble indices in the preamble index group for the plurality of PRACH repetitions may be equally divided into M groups, with each group mapped to the number of available PRACH repetitions.

M may be the maximum number of the PRACH repetitions to be supported.

### Variation

There may be no explicit /dication/ configuration for the plurality of PRACH repetitions.

### Example

If the number of preamble indexnumber per SSB and per valid RO is R, the rule for the distribution of preamble index/indices may be used. For example, M preamble indices from the first/last may be for the PRACH without repetition, and the remaining (R-M) preamble index/indices may be equally distributed for a plurality of candidate values of the number of the PRACH repetitions. The value of M or M/R may be a fixed value defined in the specification or may be configured/indicated by the base station via the SIB/RRC IE/DCI/MAC CE.

### Embodiment #2-4

The RRC IE for the configuration of the preamble index may be in accordance with the following several examples.

### Example 1

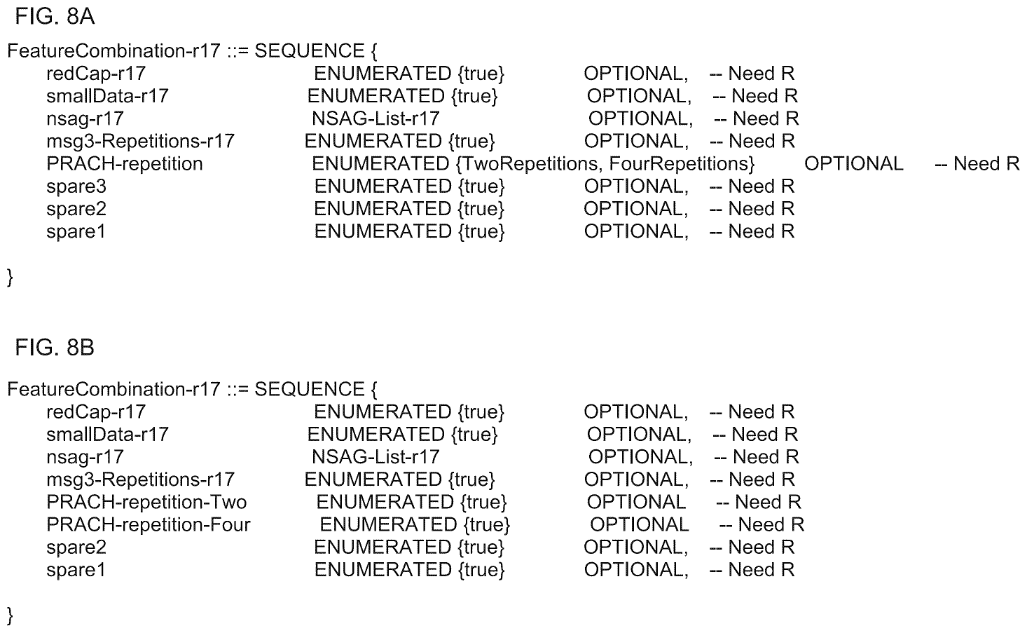

One of a plurality of spares in an existing FeatureCombination may be replaced by a PRACH repetition feature. The number of repetitions may also be determined by that PRACH repetition feature. In the example of FIG. 8A, the PRACH repetition feature (for example, the PRACH-repetition) in the FeatureCombination indicates that the feature combination configuration (FeatureCombination-r18) indicates any one of the numbers of the PRACH repetitions (TwoRepetitions, FourRepetitions). The FeatureCombination may be the enhancement of FeatureCombination-r17 or the new FeatureCombination (for example, FeatureCombination-r18).

### Example 2

The plurality of spares in the existing FeatureCombination may be replaced by a plurality of PRACH repetition features. Each of those plurality of PRACH repetition features may be associated with different numbers of repetitions. In the example of FIG. 8B, FeatureCombination-r18 may include the PRACH repetition feature associated with the number of repetitions of two (for example, a PRACH-repetition-Two) or the PRACH repetition feature associated with the number of repetitions of four (for example, a PRACH-repetition-Four). The FeatureCombination may be the enhancement of FeatureCombination-r17 or the new FeatureCombination (for example, FeatureCombination-r18).

According to this embodiment, the UE can properly determine the preamble resource for the number of the PRACH repetitions.

### Embodiment #3

This embodiment relates to problem 3.

### Embodiment #3-1

For the plurality of PRACH repetitions based on the PDCCH order, a plurality of PRACH mask indices may be indicated by the PDCCH that commands the plurality of PRACH repetitions.

An indication of the PRACH mask index may be in accordance with at least one of the following several options/variations.

### Option 1-1

The indication of the PRACH mask index may be a plurality of PRACH mask index fields in the PDCCH that commands the RACH.

### Variation 1

The number of the PRACH mask index fields may be equal to the maximum number of the PRACH repetitions to be supported. For example, whether each PRACH mask index is valid or invalid may be defined in the specification or configured by the RRC. The number of fields indicating a valid PRACH mask index may imply the number of the PRACH repetitions.

### Variation 2

The number of the PRACH mask index fields may be equal to the number of the PRACH repetitions that is explicitly indicated. For example, the number of the PRACH repetitions may be indicated by an explicit field. The UE may determine the number of the PRACH mask index fields based on the number of the PRACH repetitions to be indicated.

### Option 1-2

The indication of the PRACH mask index may be one PRACH mask index field in the PDCCH that commands the RACH. A new table including one or more PRACH mask indices in each row (entry) may be introduced. The new table may be the association of a PRACH mask index field value and the PRACH mask index for each repetition. The PRACH mask index field may indicate the entry for that new table. Based on a indicated entry, the UE may determine whether one or more PRACH mask indices are for the PRACH without repetition or for the PRACH with repetition. The UE may (implicitly) determine the number of the PRACH repetitions based on the indicated entry.

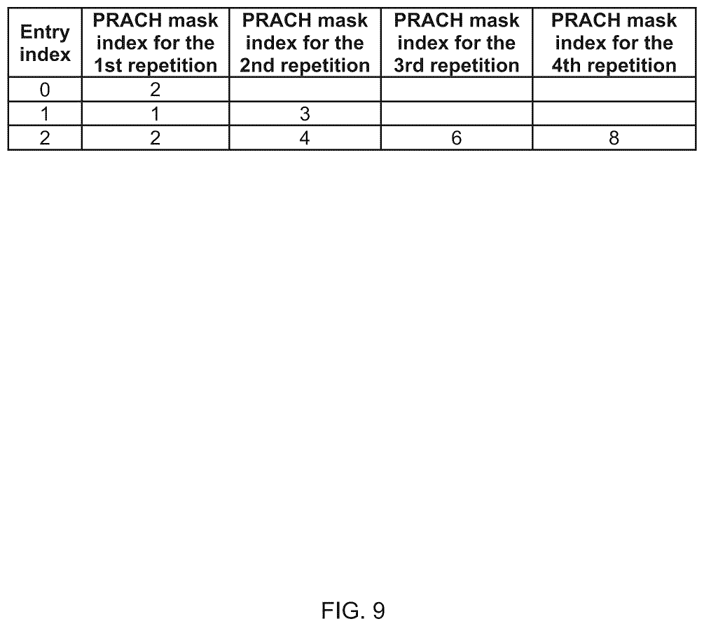

In the example of FIG. 9, each entry in the new table may include a value of an entry (row) index (PRACH mask index field) and a value of the PRACH mask index for each of one or more repetitions.

### Variation of Option 1

If separate RACH configuration indices are configured/indicated for the indices/numbers of the different repetitions, each PRACH mask index may be interpreted based on a corresponding RACH configuration index.

### Option 2

One PRACH mask index may be indicated by the PDCCH that commands the plurality of PRACH repetitions. The PRACH mask index field and its interpretation may not be enhanced. How the RO for the plurality of PRACH repetitions is determined may be defined in the specification. Based on the corresponding RACH configuration index for each of the PRACH repetitions, a indicated PRACH mask index may be interpreted.

### Embodiment #3-2

For the plurality of PRACH repetitions initiated by the MAC CE, the indication of the PRACH mask index may be in accordance with at least one of the following several options/variations.

### Option 1

The plurality of PRACH mask indices may be configured for the plurality of PRACH repetitions. For example, the plurality of PRACH mask indices for the plurality of PRACH repetitions may be configured in at least one of the CFRA configuration (CFRA), the two-step CFRA configuration (CFRA-TwoStep), a system information (SI) request resource configuration (SI-RequestResources) and a beam failure recovery configuration (BeamFailureRecoveryConfig).

An SI-RequestResources is used for a request of an SI message. The BeamFailureRecoveryConfig is used to configure the RACH resource and a candidate beam to the UE for a beam failure recovery in the case of a beam failure detected.

### Variation of Option 1

If the separate RACH configuration indices are configured/indicated for the indices/numbers of the different repetitions, each PRACH mask index may be interpreted based on the corresponding RACH configuration index.

For example, separate PRACH mask indices may be configured for each of the PRACH repetitions for the CFRA.

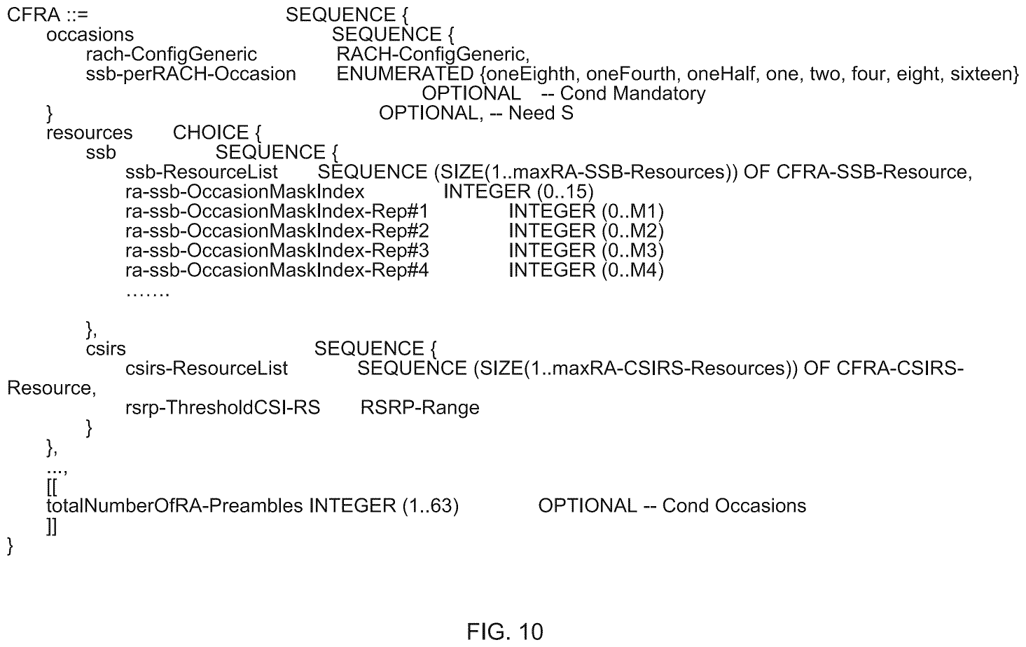

In the example of FIG. 10, the CFRA configuration (CFRA) may include the PRACH mask index for each repetition (ra-ssb-OccasionMaskIndex-Rep #1, ra-ssb-OccasionMaskIndex-Rep #2, ra-ssb-OccasionMaskIndex-Rep #3, ra-ssb-OccasionMaskIndex-Rep #4,.)

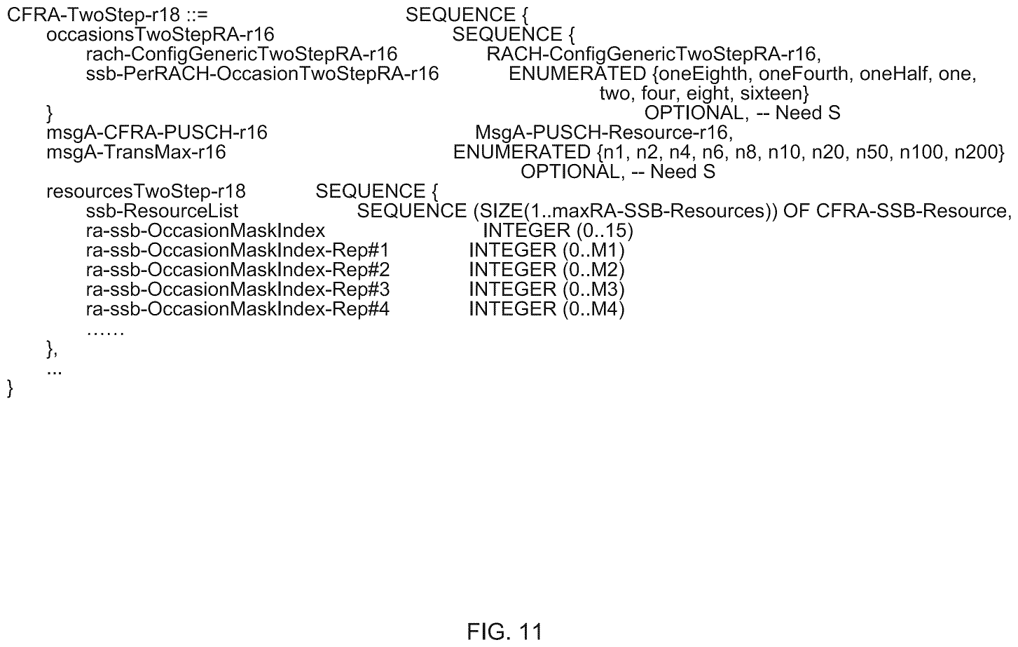

In the example of FIG. 11, the two-step CFRA configuration (CFRA-TwoStep-r18) may include the PRACH mask index for each repetition (ra-ssb-OccasionMaskIndex-Rep #1, ra-ssb-OccasionMaskIndex-Rep #2, ra-ssb-OccasionMaskIndex-Rep #3, ra-ssb-OccasionMask Index-Rep #4, . . . ).

For example, the separatePRACH mask indices may be configured for each of the PRACH repetitions for at least one of the system information (SI) and the beam failure recovery.

### Variation

For the SI, separate RA preamble starting indices (ra-PreambleStartIndex)/RA association period index (ra-AssociationPeriodIndex)/PRACH mask index (ra-ssb-OccasionMaskIndex) may be configured for each of the PRACH repetitions. If N SSBs are associated with one RO, for an i-th SSB, the preamble having the preamble index=ra-PreambleStartIndex+1 is used for an SI request. An ra-AssociationPeriodIndex indicates the index of the association period during which the UE can transmit the SI request for the SI message corresponding to the SI-RequestResource out of an si-RequestPeriod.

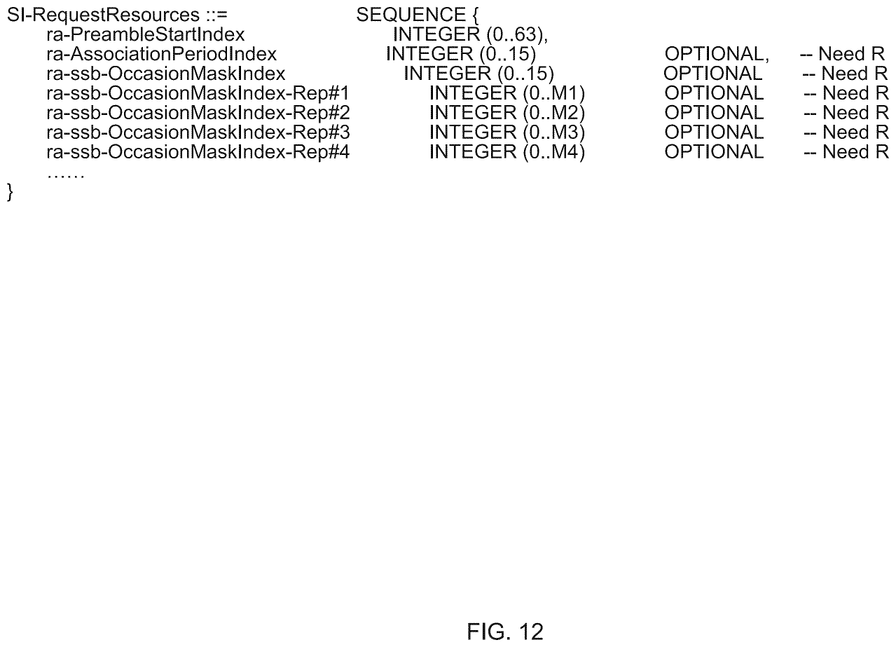

In the example of FIG. 12, the SI-RequestResources may include the ra-PreambleStartIndex, the ra-AssociationPeriodIndex and the PRACH mask indices for each of the repetitions (ra-ssb-OccasionMaskIndex-Rep #1, ra-ssb-OccasionMaskIndex-Rep #2, ra-ssb-OccasionMaskIndex-Rep #3, ra-ssb-OccasionMaskIndex-Rep #4, . . . ).

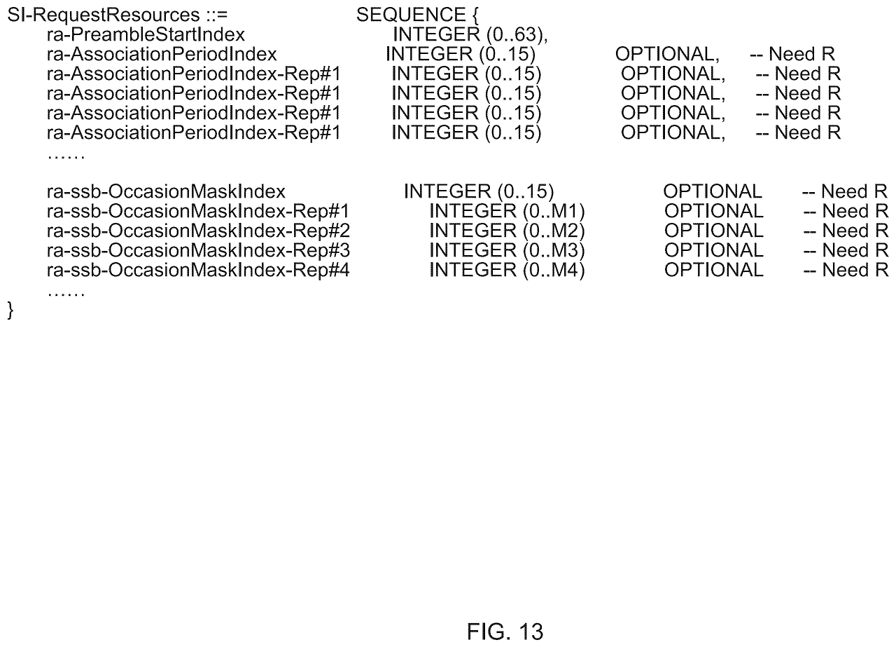

In the example of FIG. 13, the SI-RequestResources may include the ra-PreambleStartIndex, the RA association period indices for each of the repetitions (rra-AssociationPeriodIndex-Rep #1, ra-AssociationPeriodIndex-Rep #2, ra-AssociationPeriodIndex-Rep #3, ra-AssociationPeriodIndex-Rep #4,.) and the PRACH mask indices for each of the repetitions (ra-ssb-OccasionMaskIndex-Rep #1, ra-ssb-OccasionMaskIndex-Rep #2, ra-ssb-OccasionMaskIndex-Rep #3, ra-ssb-OccasionMaskIndex-Rep #4, . . . ) .

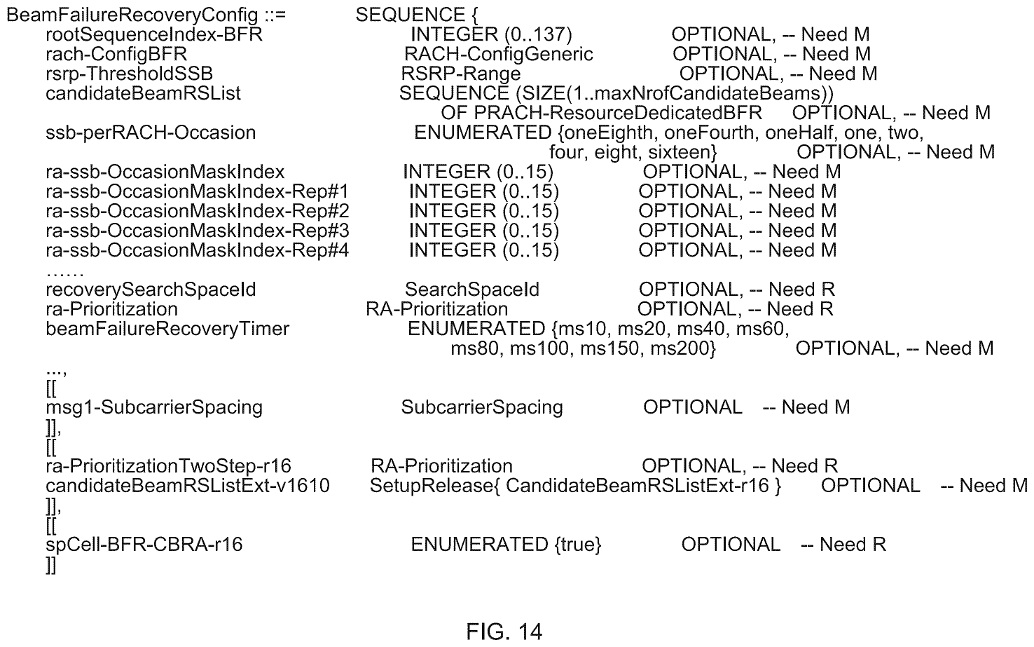

In the example of FIG. 14, the BeamFailureRecoveryConfig may include the PRACH mask indices for each of the repetitions (ra-ssb-OccasionMaskIndex-Rep #1, ra-ssb-OccasionMaskIndex-Rep #2, ra-ssb-OccasionMaskIndex-Rep #3, ra-ssb-OccasionMaskIndex-Rep #4, . . . ).

### Option 2

One PRACH mask index may be configured for the plurality of PRACH repetitions. For example, one PRACH mask index for the plurality of PRACH repetitions may be configured in at least one of the CFRA, the CFRA-TwoStep, the SI-RequestResources and the BeamFailureRecoveryConfig.

If the separete RACH configuration indices are configure/indicated for the indices/numbers of the different repetitions, one PRACH mask index to be configured may be interpreted for each of the PRACH repetitions based on the corresponding RACH configuration index.

If the separate RACH configuration indices are not configured/indicated for the indices/numbers of the different repetitions, the UE may determine one PRACH mask index to be configured for the determination of the first PRACH repetition. Subsequent repetitions may be determined in the same manner as in Embodiment #3-3 described below.

### Embodiment #3-3

This embodiment relates to a selection of the RO.

If a repetitve transmission is indicated for a PDCCH order PRACH, the UE may select the RO (for actual transmission) from one or more indicated ROs that are available next, from all repetition RO resources corresponding to a indicated SSB and a indicated number of repetitions.

The UE may be in accordance with at least one of the following methods of selection 1 and 2.

### Method of Selection 1

An indexing of the RO (repetition resource pattern) may be per SSB/per repetition/per mapping cycle. If RO #x that is available next is a first repetition configuration resource, the UE may select RO #x of the i-th, (i+1) th, (i+2) th, . . . repetition configuration resource for transmission (as the RO for actual transmission) until (the number of the ROs for transmission) reaches the indicated number of repetitions.

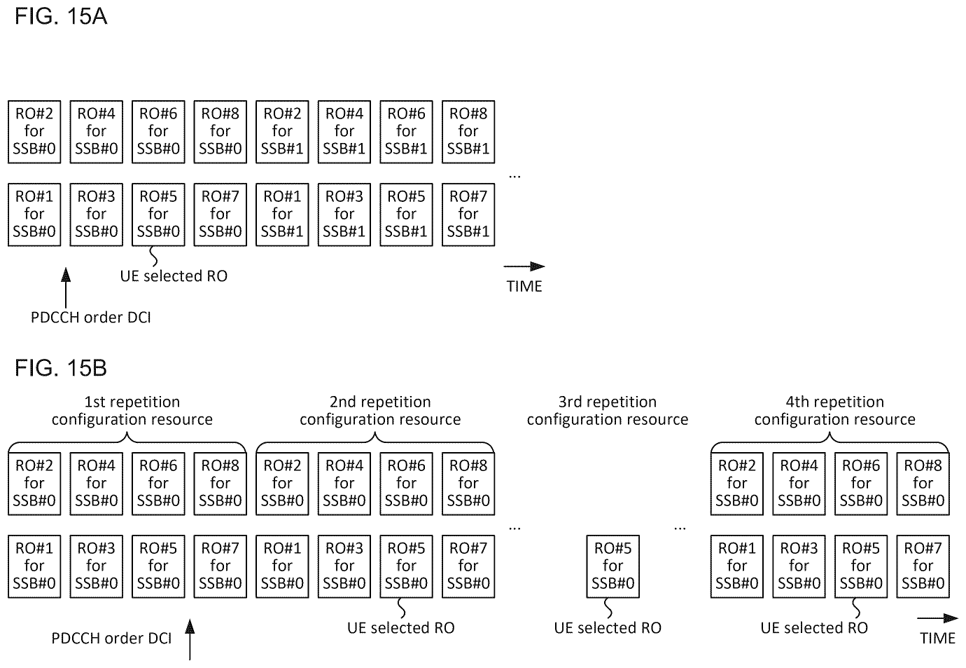

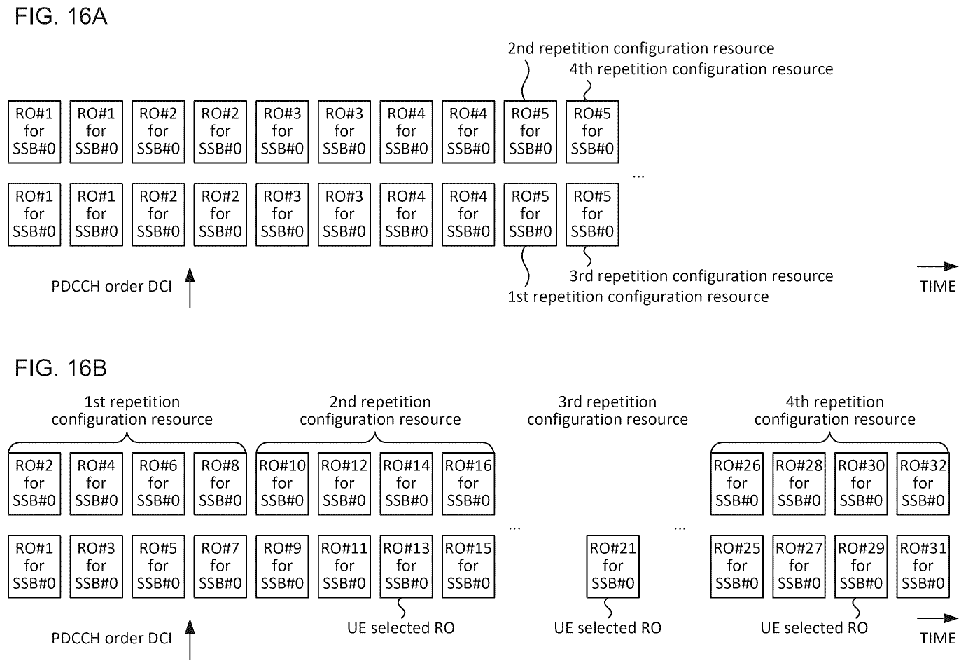

In the examples of FIGS. 15A, 15B, 16A and 16B, if the ssb-perRACH-OccasionAndCB-PreamblesPerSSB indicates oneEighth, n16 (N=⅛, R=16) and the msg1-FDM is 2, then two ROs are FDMed to one time instance, and eight ROs are mapped to one SSB.

FIG. 15A Is an Example of an Existing Ssb-ro Mapping (number of repetitions=1). The PDCCH order DCI is received between a first time instance and a second time instance. That DCI indicates SSB0 and RO #5. The UE selects the RO that is available next for the indicated SSB.

In other embodiments, this embodiment may be used to select the RO for actual transmission.

FIG. 15B is an example of the repetition resource pattern per SSB. Each of the repetition configuration resources corresponds to each of the eight ROs mapped to one SSB. The PDCCH order DCI is received between a third time instance and a fourth time instance. That DCI indicates SSB0 and RO #5. The UE selects the ROs from the RO that is available next to the indiated number of repetitions for the indicated SSB (SSB0 and RO #5) for transmission.

FIG. 16A is an example of the repetition resource pattern per SSB and per RO. Each of the repetition configuration resources corresponds to one SSB and one RO. The PDCCH order DCI is received between the third time instance and the fourth time instance. That DCI indicates SSB0 and RO #5. The UE selects the ROs from the RO that is available next to the indicated number of repetitions for the indicated SSB (SSB0 and RO #5) for transmission.

### Method of Selection 2

The indexing of the RO (repetition resource pattern) may be per SSB or per mapping cycle for all repetitions. Assuming that repetition resource patterns are configured per SSB, the i-th repetition for indicated RO #x (for example, x=1, 2, . . ., 8) may be regarded as RO #(x+i*M) (i=0, 1, 2, . . . ) , where M is the maximum number of ROs per SSB. The UE may select the ROs from one or more indicated ROS #(x+i*M) that are available next for transmission (as the ROs for actual transmission) in a repetition period until it reaches the indicated number of repetitions.

For example, for the indicated preamble index, the order of the PRACH occasions may be as follows.
First, the increasing order of the frequency resource index for the PRACH occasion that is frequency-multiplexed.
Second, the increasing order of the time resource index for the PRACH occasion that is time-multiplexed in the PRACH slot.
Third, the ascending order of the index of the PRACH slot.
Fourth, an ascending order of the number of repetitions (repetition number).

For example, the order of the PRACH occasions corresponding to a same repetition number may be in the ascending order of the index of the PRACH slot. For example, the order of the PRACH occasions corresponding to a same PRACH slot may be in the increasing order of the time resource index. For example, the order of the (frequency-multiplexed) PRACH occasions corresponding to a same time resource index may be in the increasing order of the frequency resource index.

FIG. 16B is an example of the repetition resource pattern per SSB. Each of the repetition configuration resources corresponds to each of the eight ROs mapped to one SSB. The PDCCH order DCI is received between the third time instance and the fourth time instance. That DCI indicates SSB0 and RO #5. If M=8, and RO #5 is indicated, then that indication also means an indication of ROs #13, #21 and #29. The UE may select the RO for actual transmission from those ROs based on the indicated number of repetitions. The UE selects RO #(x+i*M) from the RO that is available next to the indicated number of repetitions for the indicated SSB for transmission.

The indexing of the RO in methods of selection 1 and 2 may be applied not only to the PDCCH order PRACH but also to other PRACH resource configurations.

According to this embodiment, the UE can properly determine the PRACH mask index of the repetition of the PRACH based on the PDCCH order.

### Embodiment #4

This embodiment relates to problem 4.

An implicit determination/notification of an RO resource for the PRACH repetition may be supported.

The RO for the first repetition may be configured by the RACH configuration or may be indicated by the PDCCH order, as in an existing RO determination procedure with no repetition.

The RO for the later repetitions (second and subsequent repetitions) may be implicitly determined based on the first repetition and the repetition index. Each of the plurality of PRACH repetitions may be transmitted in one time unit (repetition based on the time unit). The time unit may be a subslot/slot/subframe/frame. The index/position of the time unit may be considered for the determination of the RO for the later repetition.

The frequency domain resource assignment/allocation (FDRA) for each of later PRACH repetitions may be the same as an FDRA for the first PRACH repetition. A frequency hopping for the plurality of PRACH repetitions may be allowed. A frequency hopping offset may be configured/indicated by the SIB/RRC configuration/PDCCH order/MAC CE. Activation/deactivation of the frequency hopping may be configured/indicated by the SIB/RRC configuration/PDCCH order/MAC CE.

Regarding a time domain resource assignment/allocation (TDRA) for each of the later PRACH repetitions, the time unit of the later PRACH repetition is after the time unit of an earlier PRACH repetition, and each PRACH repetition may be configured/indicated using an offset in a granularity of the symbol/slot/subframe from the start of each time unit.

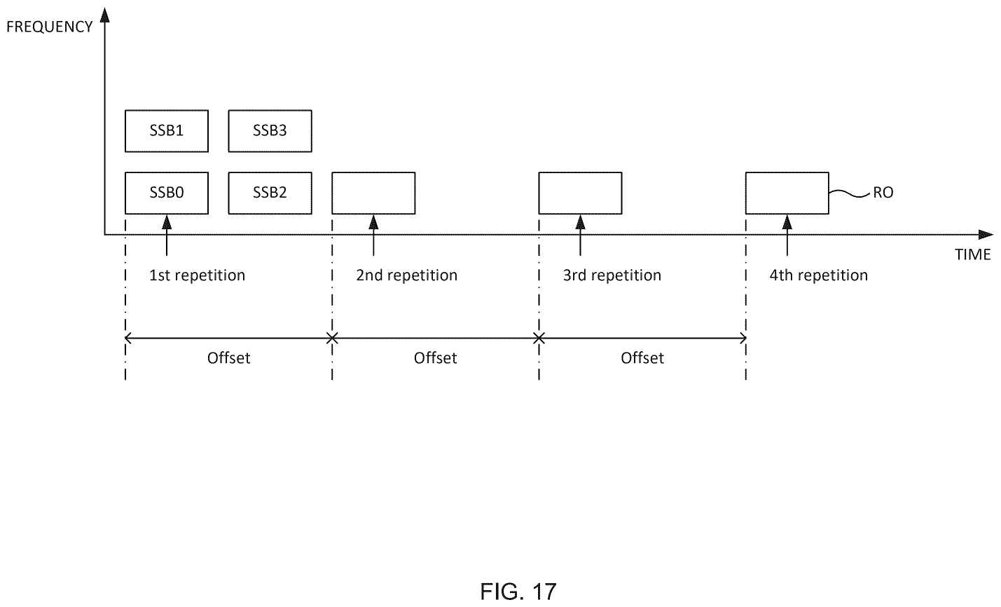

In the example of FIG. 17, the UE determines the RO corresponding to SSB0 for the first PRACH repetition. For the second PRACH repetition, the UE may determine the RO including the time resource of the RO for the first PRACH repetition with an offset added to it and a same frequency resource as the RO for the first PRACH repetition. For the third PRACH repetition, the UE may determine the RO including the time resource of the RO for the second PRACH repetition with an offset added to it and the same frequency resource as the RO for the first PRACH repetition. For the fourth PRACH repetition, the UE may determine the RO including the time resource of the RO for the third PRACH repetition with an offset added to it and the same frequency resource as the RO for the first PRACH repetition.

For the RACH based on the PDCCH order with the plurality of PRACH repetitions, the PDCCH order may indicate a gap/offset between the plurality of ROs for a plurality of consecutive repetitions. That gap may be indicated by the granularity of the subslot/slot/subframe/frame.

Validity may be considered for the TDRA for each of a plurality of later PRACH repetitions.

Regarding the TDRA for each of the later PRACH repetitions, a valid time unit of the later PRACH repetition is after the time unit of the earlier PRACH repetition, and each PRACH repetition may be configured/indicated using the offset in the granularity of the symbol/slot/subframe from the start of each time unit.

A definition of the valid time unit may require one or more of the following several conditions.
The number of symbols/slots/subframes indicated as the UL in that time unit by at least one of a common TDD-UL-DL configuration (TDD-UL-DL-ConfigCommon) and an dedicated TDD-UL-DL configuration (TTDD-UL-DL-ConfigDedicated) is N or larger.
The number of symbols/slots/subframes indicated as a DL in that time unit by at least one of the common TDD-UL-DL configuration (TDD-UL-DL-ConfigCommon) and the dedicated TDD-UL-DL configuration (TTDD-UL-DL-ConfigDedicated) is N or larger.
The TDRA for the PRACH repetition determined in that time unit does not overlap with any symbols indicated as at least one of the UL and a flexible by at least one of the common TDD-UL-DL configuration (TDD-UL-DL-ConfigCommon) and the dedicated TDD-UL-DL configuration (TTDD-UL-DL-ConfigDedicated).
There is a valid RACH occasion resource in that time unit.

The PRACH repetitions in the time unit that is invalid may or may not be counted in the total number of the PRACH repetitions.

According to this embodiment, the UE can properly determine the plurality of ROS for the plurality of PRACH repetitions.

### Supplemental

In each embodiment, the UE may use the same beam/TCI state/spatial relation for the plurality of PRACH repetitions. In each embodiment, the UE may detect the SSB having a maximum received power and select the RO corresponding to that SSB for the plurality of PRACH repetitions.

The base station may receive a corresponding PRACH repetition using at least one of a plurality of resources (RO/preamble). The base station may perform the soft combining using at least two of the plurality of PRACH repetitions.

### Notification of Information to the UE

The notification of any information (from the network (NW) (for example, the base station (BS))) to the UE (in other words, a reception of any information from the BS by the UE) in the embodiments described above may be performed using the physical layer signaling (for example, the DCI), the higher layer signaling (for example, an RRC signaling and the MAC CE), a specific signal/channel (for example, the PDCCH, the PDSCH and the reference signal), or a combination thereof.

When the above notification is performed by the MAC CE, such MAC CE may be identified based on the inclusion of a new logical channel ID (LCID) that is not specified in an existing standard in an MAC subheader.

When the above notification is performed by the DCI, the above notification may be performed by a specific field of such DCI, a Radio Network Temporary Identifier (RNTI) used to scramble Cyclic Redundancy Check (CRC) bits that are attached to such DCI, the format of such DCI, etc.

The notification of any information to the UE in the above embodiments may be performed in a periodic, semi-persistent or aperiodic manner.

### Notification of Information From the Ue

The notification of any information from the UE (to the NW) (in other words, the transmission/reporting of any information to the BS by the UE) in the embodiments described above may be performed using the physical layer signaling (for example, the UCI), the higher layer signaling (for example, the RRC signaling and the MAC CE), the specific signal/channel (for example, the PUCCH, the PUSCH, the PRACH and the reference signal), or a combination thereof.

When the above notification is performed by the MAC CE, such MAC CE may be identified based on the inclusion of the new LCID that is not specified in the existing standard in the MAC subheader.

When the above notification is performed by the UCI, the above notification may be transmitted using the PUCCH or the PUSCH.

The notification of any information from the UE in the above embodiments may be performed in a periodic, semi-persistent or aperiodic manner.

### For the Application of Each Embodiment

At least one of the above embodiments may be applied when specific conditions are met. Such specific conditions may be specified in the standard or notified to the UE/BS using the higher layer signaling/physical layer signaling.

At least one of the embodiments described above may be applied only to the UE that has reported a specific UE capability or that supports such specific UE capability.

Such specific UE capability may indicate at least one of the following.
Support of an individual RO resource for the index/number of the different repetitions.
Support of an individual preamble index resource for the index/number of the different repetitions.
Support of the plurality of PRACH mask indices indicated by the PDCCH order (individual PRACH mask indices for the index/number of the different repetitions).
Support of an implicit RO resource determination for the plurality of PRACH repetitions.

The specific UE capability described above may also be a capability that applies across all frequencies (in common regardless of frequency), a capability for each frequency (for example, one or a combination of cell, band, band combination, BWP, component carrier, etc.), a capability for each frequency range (for example, Frequency Range 1 (FR1), FR2, FR3, FR4, FR5, FR2-1 and FR2-2), a capability for each SubCarrier Spacing (SCS), or a capability for each Feature Set (FS) or Feature Set Per Component-carrier (FSPC).

The specific UE capability described above may also be a capability that applies across all duplex systems (in common regardless of duplex system) or a capability for each duplex system (for example, time division duplex (TDD) and frequency division duplex (FDD)).

At least one of the embodiments described above may also be applied when the UE is configured/activated/triggered with specific information related to the embodiments described above (or to perform an operation of the embodiments described above) by the higher layer signaling/physical layer signaling. For example, such specific information may be information indicating an activation of a feature of each embodiment, any RRC parameter for a specific release (for example, Rel. 18/19), etc.

When the UE does not support at least one of the specific UE capabilities described above or is not configured with the specific information described above, the UE may apply the operation of, for example, Rel. 15/16.

### Supplementary Note

Regarding one embodiment of the present disclosure, the following supplementary notes of the invention will be given.

### Supplementary Note 1

A terminal including: a control section that determines each of a plurality of resources for a plurality of repetitions of a physical random access channel (PRACH) ; and a transmitting section that transmits each of the plurality of repetitions using the plurality of resources.

### Supplementary Note 2

The terminal according to supplementary note 1, wherein each of the plurality of resources is at least one of a random access channel occasion and a random access preamble.

### Supplementary Note 3

The terminal according to supplementary note 1 or 2, wherein the control section determines each of a plurality of PRACH mask indices for the plurality of repetitions, based on a physical downlink control channel (PDCCH) order or a medium access control (MAC) control element (CE).

### Supplementary Note 4

The terminal according to any one of supplementary notes 1 to 3, wherein the control section determines a plurality of random access channel occasions for the plurality of repetitions, based on a random access channel configuration or a PDCCH order.

### Radio Communication System

Hereinafter, a structure of a radio communication system according to one embodiment of the present disclosure will be described. In this radio communication system, the radio communication method according to each embodiment of the present disclosure described above may be used alone or may be used in combination for communication.

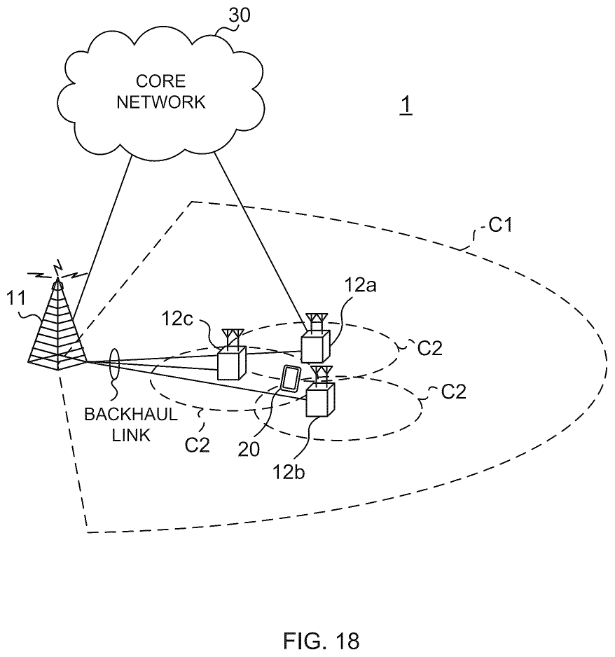

FIG. 18 is a diagram to show an example of a schematic structure of the radio communication system according to one embodiment. The radio communication system 1 (which may be simply referred to as a system 1) may be a system implementing a communication using Long Term Evolution (LTE), 5th generation mobile communication system New Radio (5G NR) and so on the specifications of which have been drafted by Third Generation Partnership Project (3GPP).

The radio communication system 1 may support dual connectivity (multi-RAT dual connectivity (MR-DC) ) between a plurality of Radio Access Technologies (RATs). The MR-DC may include dual connectivity (E-UTRA-NR Dual Connectivity (EN-DC)) between LTE (Evolved Universal Terrestrial Radio Access (E-UTRA)) and NR, dual connectivity (NR-E-UTRA Dual Connectivity (NE-DC)) between NR and LTE, and so on.

In EN-DC, a base station (eNB) of LTE (E-UTRA) is a master node (MN), and a base station (gNB) of NR is a secondary node (SN). In NE-DC, a base station (gNB) of NR is an MN, and a base station (eNB) of LTE (E-UTRA) is an SN.

The radio communication system 1 may support dual connectivity between a plurality of base stations in the same RAT (for example, dual connectivity (NR-NR Dual Connectivity (NN-DC)) where both of an MN and an SN are base stations (gNB) of NR).

The radio communication system 1 may include a base station 11 that forms a macro cell C1 of a relatively wide coverage, and base stations 12 (12a to 12c) that form small cells C2, which are placed within the macro cell C1 and which are narrower than the macro cell C1. The user terminal 20 may be located in at least one cell. The arrangement, the number, and the like of each cell and user terminal 20 are by no means limited to the aspect shown in the diagram. Hereinafter, the base stations 11 and 12 will be collectively referred to as “base stations 10,” unless specified otherwise.

The user terminal 20 may be connected to at least one of the plurality of base stations 10. The user terminal 20 may use at least one of carrier aggregation (CA) and dual connectivity (DC) using a plurality of component carriers (CCs).

Each CC may be included in at least one of a first frequency band (Frequency Range 1 (FR1) ) and a second frequency band (Frequency Range 2 (FR2)). The macro cell C1 may be included in FR1, and the small cells C2 may be included in FR2. For example, FR1 may be a frequency band of 6 GHz or less (sub-6 GHz), and FR2 may be a frequency band which is higher than 24 GHZ (above-24 GHz). Note that frequency bands, definitions and so on of FR1 and FR2 are by no means limited to these, and for example, FR1 may correspond to a frequency band which is higher than FR2.

The user terminal 20 may communicate using at least one of time division duplex (TDD) and frequency division duplex (FDD) in each CC.

The plurality of base stations 10 may be connected by a wired connection (for example, optical fiber in compliance with the Common Public Radio Interface (CPRI), the X2 interface and so on) or a wireless connection (for example, an NR communication). For example, if an NR communication is used as a backhaul between the base stations 11 and 12, the base station 11 corresponding to a higher station may be referred to as an “Integrated Access Backhaul (IAB) donor,” and the base station 12 corresponding to a relay station (relay) may be referred to as an “IAB node.”

The base station 10 may be connected to a core network 30 through another base station 10 or directly. For example, the core network 30 may include at least one of Evolved Packet Core (EPC), 5G Core Network (5GCN), Next Generation Core (NGC), and so on.

The core network 30 may include network functions (NF) such as a User Plane Function (UPF), an Access and Mobility Management Function (AMF), a Session Management Function (SMF), Unified Data Management (UDM), an Application Function (AF), a Data Network (DN), a Location Management Function (LMF), and operation, administration, and maintenance (Management) (OAM). Note that a plurality of functions may be provided by one network node. Communication with an external network (for example, the Internet) may be performed via the DN.

The user terminal 20 may be a terminal supporting at least one of communication schemes such as LTE, LTE-A, 5G, and so on.

In the radio communication system 1, an orthogonal frequency division multiplexing (OFDM)-based wireless access scheme may be used. For example, in at least one of the downlink (DL) and the uplink (UL), Cyclic Prefix OFDM (CP-OFDM), Discrete Fourier Transform Spread OFDM (DFT-s-OFDM), Orthogonal Frequency Division Multiple Access (OFDMA), Single Carrier Frequency Division Multiple Access (SC-FDMA), and so on may be used.

The wireless access scheme may be referred to as a “waveform.” Note that, in the radio communication system 1, another wireless access scheme (for example, another single carrier transmission scheme, another multi-carrier transmission scheme) may be used for a wireless access scheme in the UL and the DL.

In the radio communication system 1, a downlink shared channel (Physical Downlink Shared Channel (PDSCH)), which is used by each user terminal 20 on a shared basis, a broadcast channel (Physical Broadcast Channel (PBCH)), a downlink control channel (Physical Downlink Control Channel (PDCCH)) and so on, may be used as downlink channels.

In the radio communication system 1, an uplink shared channel (Physical Uplink Shared Channel (PUSCH)), which is used by each user terminal 20 on a shared basis, an uplink control channel (Physical Uplink Control Channel (PUCCH)), a random access channel (Physical Random Access Channel (PRACH)) and so on may be used as uplink channels.

User data, higher layer control information, System Information Blocks (SIBs) and so on are transmitted on the PDSCH. User data, higher layer control information and so on may be transmitted on the PUSCH. The Master Information Blocks (MIBs) may be transmitted on the PBCH.

Lower layer control information may be transmitted on the PDCCH. For example, the lower layer control information may include downlink control information (DCI) including scheduling information of at least one of the PDSCH and the PUSCH.

Note that DCI for scheduling the PDSCH may be referred to as “DL assignment,” “DL DCI,” and so on, and DCI for scheduling the PUSCH may be referred to as “UL grant,” “UL DCI,” and so on. Note that the PDSCH may be interpreted as “DL data”, and the PUSCH may be interpreted as “UL data”.

For detection of the PDCCH, a control resource set (CORESET) and a search space may be used. The CORESET corresponds to a resource to search DCI. The search space corresponds to a search area and a search method of PDCCH candidates. One CORESET may be associated with one or more search spaces. The UE may monitor a CORESET associated with a certain search space, based on search space configuration.

One search space may correspond to a PDCCH candidate corresponding to one or more aggregation levels. One or more search spaces may be referred to as a “search space set.” Note that a “search space,” a “search space set,” a “search space configuration,” a “search space set configuration,” a “CORESET,” a “CORESET configuration” and so on of the present disclosure may be used interchangeably.

Uplink control information (UCI) including at least one of channel state information (CSI), transmission confirmation information (for example, which may be referred to as Hybrid Automatic Repeat reQuest ACKnowledgement (HARQ-ACK), ACK/NACK, and so on), and scheduling request (SR) may be transmitted by means of the PUCCH. By means of the PRACH, random access preambles for establishing connections with cells may be transmitted.

Note that the downlink, the uplink, and so on in the present disclosure may be expressed without a term of “link.” In addition, various channels may be expressed without adding “Physical” to the head.

In the radio communication system 1, a synchronization signal (SS), a downlink reference signal (DL-RS), and so on may be transmitted. In the radio communication system 1, a cell-specific reference signal (CRS), a channel state information-reference signal (CSI-RS), a demodulation reference signal (DMRS), a positioning reference signal (PRS), a phase tracking reference signal (PTRS), and so on may be transmitted as the DL-RS.

For example, the synchronization signal may be at least one of a primary synchronization signal (PSS) and a secondary synchronization signal (SSS). A signal block including an SS (PSS, SSS) and a PBCH (and a DMRS for a PBCH) may be referred to as an “SS/PBCH block,” an “SS Block (SSB),” and so on. Note that an SS, an SSB, and so on may be referred to as a “reference signal.”

In the radio communication system 1, a sounding reference signal (SRS), a demodulation reference signal (DMRS), and so on may be transmitted as an uplink reference signal (UL-RS). Note that DMRS may be referred to as a “user terminal specific reference signal (UE-specific Reference Signal).”

### Base Station

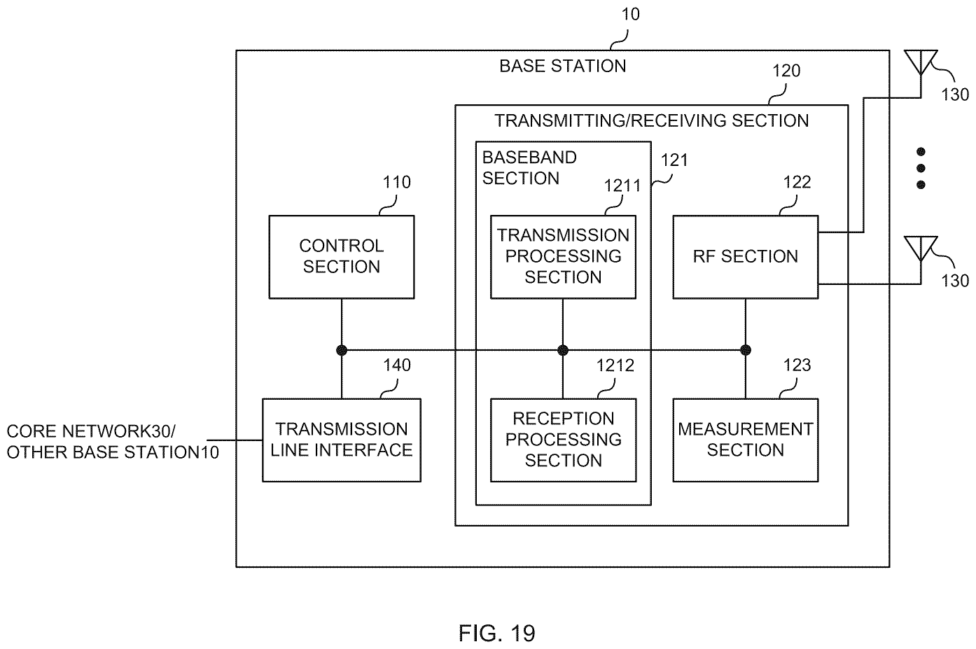

FIG. 19 is a diagram to show an example of a structure of the base station according to one embodiment. The base station 10 includes a control section 110, a transmitting/receiving section 120, transmitting/receiving antennas 130 and a transmission line interface 140. Note that the base station 10 may include one or more control sections 110, one or more transmitting/receiving sections 120, one or more transmitting/receiving antennas 130, and one or more transmission line interfaces 140.

Note that, the present example primarily shows functional blocks that pertain to characteristic parts of the present embodiment, and it is assumed that the base station 10 may include other functional blocks that are necessary for radio communication as well. Part of the processes of each section described below may be omitted.

The control section 110 controls the whole of the base station 10. The control section 110 can be constituted with a controller, a control circuit, or the like described based on general understanding of the technical field to which the present disclosure pertains.

The control section 110 may control generation of signals, scheduling (for example, resource allocation, mapping), and so on. The control section 110 may control transmission and reception, measurement and so on using the transmitting/receiving section 120, the transmitting/receiving antennas 130, and the transmission line interface 140. The control section 110 may generate data, control information, a sequence and so on to transmit as a signal, and forward the generated items to the transmitting/receiving section 120. The control section 110 may perform call processing (setting up, releasing) for communication channels, manage the state of the base station 10, and manage the radio resources.

The transmitting/receiving section 120 may include a baseband section 121, a Radio Frequency (RF) section 122, and a measurement section 123. The baseband section 121 may include a transmission processing section 1211 and a reception processing section 1212. The transmitting/receiving section 120 can be constituted with a transmitter/receiver, an RF circuit, a baseband circuit, a filter, a phase shifter, a measurement circuit, a transmitting/receiving circuit, or the like described based on general understanding of the technical field to which the present disclosure pertains.

The transmitting/receiving section 120 may be structured as a transmitting/receiving section in one entity, or may be constituted with a transmitting section and a receiving section. The transmitting section may be constituted with the transmission processing section 1211, and the RF section 122. The receiving section may be constituted with the reception processing section 1212, the RF section 122, and the measurement section 123.

The transmitting/receiving antennas 130 can be constituted with antennas, for example, an array antenna, or the like described based on general understanding of the technical field to which the present disclosure pertains.

The Transmitting/receiving Section 120 May Transmit the above-described downlink channel, synchronization signal, downlink reference signal, and so on. The transmitting/receiving section 120 may receive the above-described uplink channel, uplink reference signal, and so on.

The transmitting/receiving section 120 may form at least one of a transmit beam and a receive beam by using digital beam forming (for example, precoding), analog beam forming (for example, phase rotation), and so on.

The transmitting/receiving section 120 (transmission processing section 1211) may perform the processing of the Packet Data Convergence Protocol (PDCP) layer, the processing of the Radio Link Control (RLC) layer (for example, RLC retransmission control), the processing of the Medium Access Control (MAC) layer (for example, HARQ retransmission control), and so on, for example, on data and control information and so on acquired from the control section 110, and may generate bit string to transmit.

The transmitting/receiving section 120 (transmission processing section 1211) may perform transmission processing such as channel coding (which may include error correction coding), modulation, mapping, filtering, discrete Fourier transform (DFT) processing (as necessary), inverse fast Fourier transform (IFFT) processing, precoding, digital-to-analog conversion, and so on, on the bit string to transmit, and output a baseband signal.

The transmitting/receiving section 120 (RF section 122) may perform modulation to a radio frequency band, filtering, amplification, and so on, on the baseband signal, and transmit the signal of the radio frequency band through the transmitting/receiving antennas 130.

On the other hand, the transmitting/receiving section 120 (RF section 122) may perform amplification, filtering, demodulation to a baseband signal, and so on, on the signal of the radio frequency band received by the transmitting/receiving antennas 130.

The transmitting/receiving section 120 (reception processing section 1212) may apply reception processing such as analog-digital conversion, fast Fourier transform (FFT) processing, inverse discrete Fourier transform (IDFT) processing (as necessary), filtering, de-mapping, demodulation, decoding (which may include error correction decoding), MAC layer processing, the processing of the RLC layer and the processing of the PDCP layer, and so on, on the acquired baseband signal, and acquire user data, and so on.

The transmitting/receiving section 120 (measurement section 123) may perform the measurement related to the received signal.

For example, the measurement section 123 may perform Radio Resource Management (RRM) measurement, Channel State Information (CSI) measurement, and so on, based on the received signal. The measurement section 123 may measure a received power (for example, Reference Signal Received Power (RSRP) ), a received quality (for example, Reference Signal Received Quality (RSRQ), a Signal to Interference plus Noise Ratio (SINR), a Signal to Noise Ratio (SNR) ), a signal strength (for example, Received Signal Strength Indicator (RSSI) ), channel information (for example, CSI), and so on. The measurement results may be output to the control section 110.

The transmission line interface 140 may perform transmission/reception (backhaul signaling) of a signal with an apparatus (for example, a network node providing NFs) included in the core network 30 or other base stations 10, and so on, and acquire or transmit user data (user plane data), control plane data, and so on for the user terminal 20.

Note that the transmitting section and the receiving section of the base station 10 in the present disclosure may be constituted with at least one of the transmitting/receiving section 120, the transmitting/receiving antennas 130, and the transmission line interface 140.

The control section 110 may control a transmission of a configuration for determining each of a plurality of resources for a plurality of repetitions of a physical random access channel (PRACH). The transmitting/receiving section 120 may receive at least one of the plurality of repetitions using at least one of the plurality of resources.

### User Terminal

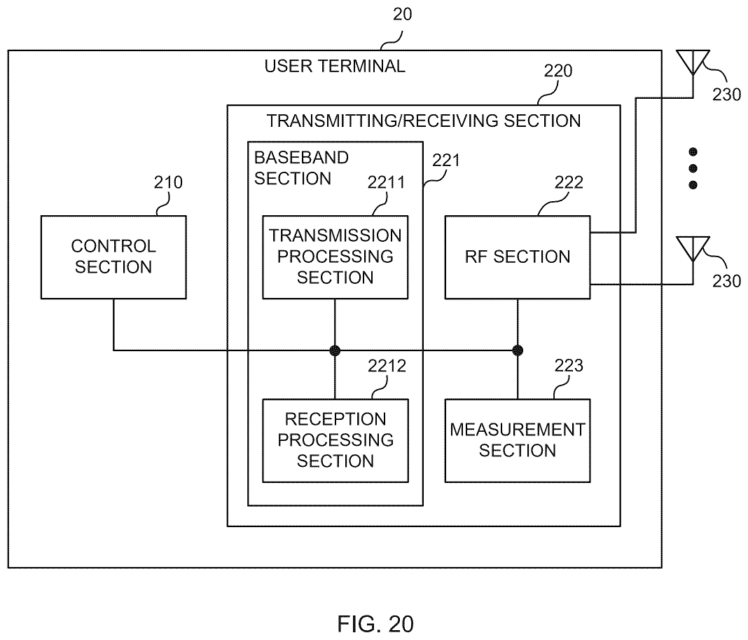

FIG. 20 is a diagram to show an example of a structure of the user terminal according to one embodiment. The user terminal 20 includes a control section 210, a transmitting/receiving section 220, and transmitting/receiving antennas 230. Note that the user terminal 20 may include one or more control sections 210, one or more transmitting/receiving sections 220, and one or more transmitting/receiving antennas 230.

Note that, the present example primarily shows functional blocks that pertain to characteristic parts of the present embodiment, and it is assumed that the user terminal 20 may include other functional blocks that are necessary for radio communication as well. Part of the processes of each section described below may be omitted.

The control section 210 controls the whole of the user terminal 20. The control section 210 can be constituted with a controller, a control circuit, or the like described based on general understanding of the technical field to which the present disclosure pertains.

The control section 210 may control generation of signals, mapping, and so on. The control section 210 may control transmission/reception, measurement and so on using the transmitting/receiving section 220, and the transmitting/receiving antennas 230. The control section 210 generates data, control information, a sequence and so on to transmit as a signal, and may forward the generated items to the transmitting/receiving section 220.

The transmitting/receiving section 220 may include a baseband section 221, an RF section 222, and a measurement section 223. The baseband section 221 may include a transmission processing section 2211 and a reception processing section 2212. The transmitting/receiving section 220 can be constituted with a transmitter/receiver, an RF circuit, a baseband circuit, a filter, a phase shifter, a measurement circuit, a transmitting/receiving circuit, or the like described based on general understanding of the technical field to which the present disclosure pertains.

The transmitting/receiving section 220 may be structured as a transmitting/receiving section in one entity, or may be constituted with a transmitting section and a receiving section. The transmitting section may be constituted with the transmission processing section 2211, and the RF section 222. The receiving section may be constituted with the reception processing section 2212, the RF section 222, and the measurement section 223.

The transmitting/receiving antennas 230 can be constituted with antennas, for example, an array antenna, or the like described based on general understanding of the technical field to which the present disclosure pertains.

The transmitting/receiving section 220 may receive the above-described downlink channel, synchronization signal, downlink reference signal, and so on. The transmitting/receiving section 220 may transmit the above-described uplink channel, uplink reference signal, and so on.

The transmitting/receiving section 220 may form at least one of a transmit beam and a receive beam by using digital beam forming (for example, precoding), analog beam forming (for example, phase rotation), and so on.

The Transmitting/receiving Section 220 (transmission

processing section 2211) may perform the processing of the PDCP layer, the processing of the RLC layer (for example, RLC retransmission control), the processing of the MAC layer (for example, HARQ retransmission control), and so on, for example, on data and control information and so on acquired from the control section 210, and may generate bit string to transmit.

The transmitting/receiving section 220 (transmission processing section 2211) may perform transmission processing such as channel coding (which may include error correction coding), modulation, mapping, filtering, DFT processing (as necessary), IFFT processing, precoding, digital-to-analog conversion, and so on, on the bit string to transmit, and output a baseband signal.

Note that, whether to apply DFT processing or not may be based on the configuration of the transform precoding. The transmitting/receiving section 220 (transmission processing section 2211) may perform, for a given channel (for example, PUSCH), the DFT processing as the above-described transmission processing to transmit the channel by using a DFT-s-OFDM waveform if transform precoding is enabled, and otherwise, does not need to perform the DFT processing as the above-described transmission processing.

The transmitting/receiving section 220 (RF section 222) may perform modulation to a radio frequency band, filtering, amplification, and so on, on the baseband signal, and transmit the signal of the radio frequency band through the transmitting/receiving antennas 230.

On the other hand, the transmitting/receiving section 220 (RF section 222) may perform amplification, filtering, demodulation to a baseband signal, and so on, on the signal of the radio frequency band received by the transmitting/receiving antennas 230.

The Transmitting/receiving Section 220 (reception Processing section 2212) may apply reception processing such as analog-digital conversion, FFT processing, IDFT processing (as necessary), filtering, de-mapping, demodulation, decoding (which may include error correction decoding), MAC layer processing, the processing of the RLC layer and the processing of the PDCP layer, and so on, on the acquired baseband signal, and acquire user data, and so on.

The transmitting/receiving section 220 (measurement section 223) may perform the measurement related to the received signal.

For example, the measurement section 223 may perform RRM measurement, CSI measurement, and so on, based on the received signal. The measurement section 223 may measure a received power (for example, RSRP), a received quality (for example, RSRQ, SINR, SNR), a signal strength (for example, RSSI), channel information (for example, CSI), and so on. The measurement results may be output to the control section 210.

Note that the transmitting section and the receiving section of the user terminal 20 in the present disclosure may be constituted with at least one of the transmitting/receiving section 220 and the transmitting/receiving antennas 230.

The control section 210 may determine each of a plurality of resources for a plurality of repetitions of a physical random access channel (PRACH). The transmitting/receiving section 220 may transmit each of the plurality of repetitions using the plurality of resources.

Each of the plurality of resources may be at least one of a random access channel occasion and a random access preamble.

The control section 210 may determine each of a plurality of PRACH mask indices for the plurality of repetitions, based on a physical downlink control channel (PDCCH) order or a medium access control (MAC) control element (CE).

The control section 210 may determine a plurality of random access channel occasions for the plurality of repetitions, based on a random access channel configuration or a PDCCH order.

### Hardware Structure

Note that the block diagrams that have been used to describe the above embodiments show blocks in functional units. These functional blocks (components) may be implemented in arbitrary combinations of at least one of hardware and software. Also, the method for implementing each functional block is not particularly limited. That is, each functional block may be realized by one piece of apparatus that is physically or logically coupled, or may be realized by directly or indirectly connecting two or more physically or logically separate pieces of apparatus (for example, via wire, wireless, or the like) and using these plurality of pieces of apparatus. The functional blocks may be implemented by combining softwares into the apparatus described above or the plurality of apparatuses described above.

Here, functions include judgment, determination, decision, calculation, computation, processing, derivation, investigation, search, confirmation, reception, transmission, output, access, resolution, selection, designation, establishment, comparison, assumption, expectation, considering, broadcasting, notifying, communicating, forwarding, configuring, reconfiguring, allocating (mapping), assigning, and the like, but function are by no means limited to these. For example, functional block (components) to implement a function of transmission may be referred to as a “transmitting section (transmitting unit), ” a “transmitter,” and the like. The method for implementing each component is not particularly limited as described above.

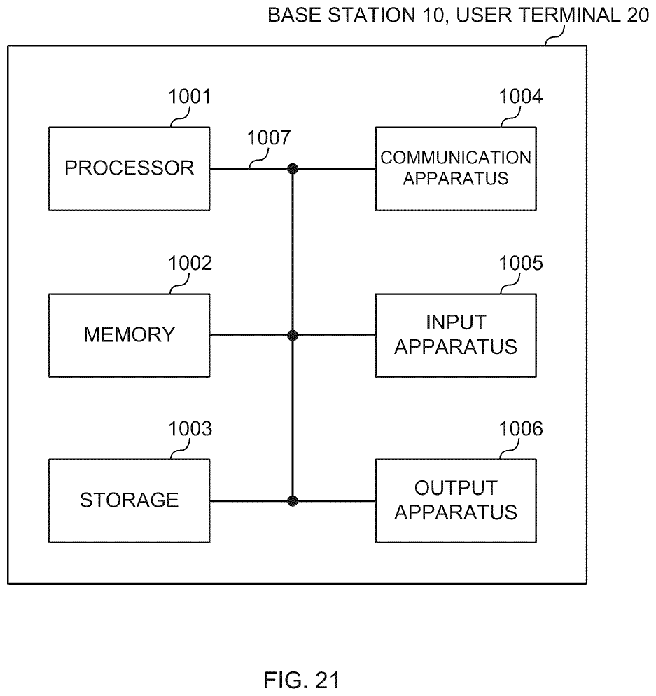

For example, a base station, a user terminal, and so on according to one embodiment of the present disclosure may function as a computer that executes the processes of the radio communication method of the present disclosure. FIG. 21 is a diagram to show an example of a hardware structure of the base station and the user terminal according to one embodiment. Physically, the above-described base station 10 and user terminal 20 may each be formed as a computer apparatus that includes a processor 1001, a memory 1002, a storage 1003, a communication apparatus 1004, an input apparatus 1005, an output apparatus 1006, a bus 1007, and so on.

Note that in the present disclosure, the words such as an apparatus, a circuit, a device, a section, a unit, and so on can be interchangeably interpreted. The hardware structure of the base station 10 and the user terminal 20 may be configured to include one or more of apparatuses shown in the drawings, or may be configured not to include part of apparatuses.

For example, although only one processor 1001 is shown, a plurality of processors may be provided. Furthermore, processes may be implemented with one processor or may be implemented at the same time, in sequence, or in different manners with two or more processors. Note that the processor 1001 may be implemented with one or more chips.

Each function of the base station 10 and the user terminals 20 is implemented, for example, by allowing given software (programs) to be read on hardware such as the processor 1001 and the memory 1002, and by allowing the processor 1001 to perform calculations to control communication via the communication apparatus 1004 and control at least one of reading and writing of data in the memory 1002 and the storage 1003.

The processor 1001 controls the whole computer by, for example, running an operating system. The processor 1001 may be configured with a central processing unit (CPU), which includes interfaces with peripheral apparatus, control apparatus, computing apparatus, a register, and so on. For example, at least part of the above-described control section 110 (210), the transmitting/receiving section 120 (220), and so on may be implemented by the processor 1001.

Furthermore, the processor 1001 reads programs (program codes), software modules, data, and so on from at least one of the storage 1003 and the communication apparatus 1004, into the memory 1002, and executes various processes according to these. As for the programs, programs to allow computers to execute at least part of the operations of the above-described embodiments are used. For example, the control section 110 (210) may be implemented by control programs that are stored in the memory 1002 and that operate on the processor 1001, and other functional blocks may be implemented likewise.

The memory 1002 is a computer-readable recording medium, and may be constituted with, for example, at least one of a Read Only Memory (ROM), an Erasable Programmable ROM (EPROM), an Electrically EPROM (EEPROM), a Random Access Memory (RAM), and other appropriate storage media. The memory 1002 may be referred to as a “register,” a “cache,” a “main memory (primary storage apparatus) ” and so on. The memory 1002 can store executable programs (program codes), software modules, and the like for implementing the radio communication method according to one embodiment of the present disclosure.

The storage 1003 is a computer-readable recording medium, and may be constituted with, for example, at least one of a flexible disk, a floppy (registered trademark) disk, a magneto-optical disk (for example, a compact disc (Compact Disc ROM (CD-ROM) and so on), a digital versatile disc, a Blu-ray (registered trademark) disk), a removable disk, a hard disk drive, a smart card, a flash memory device (for example, a card, a stick, and a key drive), a magnetic stripe, a database, a server, and other appropriate storage media. The storage 1003 may be referred to as “secondary storage apparatus.”

The communication apparatus 1004 is hardware (transmitting/receiving device) for allowing inter-computer communication via at least one of wired and wireless networks, and may be referred to as, for example, a “network device,” a “network controller,” a “network card,” a “communication module,” and so on. The communication apparatus 1004 may be configured to include a high frequency switch, a duplexer, a filter, a frequency synthesizer, and so on in order to realize, for example, at least one of frequency division duplex (FDD) and time division duplex (TDD). For example, the above-described transmitting/receiving section 120 (220), the transmitting/receiving antennas 130 (230), and so on may be implemented by the communication apparatus 1004. In the transmitting/receiving section 120 (220), the transmitting section 120a (220a) and the receiving section 120b (220b) can be implemented while being separated physically or logically.

The input apparatus 1005 is an input device that receives input from the outside (for example, a keyboard, a mouse, a microphone, a switch, a button, a sensor, and so on). The output apparatus 1006 is an output device that allows sending output to the outside (for example, a display, a speaker, a Light Emitting Diode (LED) lamp, and so on). Note that the input apparatus 1005 and the output apparatus 1006 may be provided in an integrated structure (for example, a touch panel).

Furthermore, these types of apparatus, including the processor 1001, the memory 1002, and others, are connected by a bus 1007 for communicating information. The bus 1007 may be formed with a single bus, or may be formed with buses that vary between pieces of apparatus.

Also, the base station 10 and the user terminals 20 may be structured to include hardware such as a microprocessor, a digital signal processor (DSP), an Application Specific Integrated Circuit (ASIC), a Programmable Logic Device (PLD), a Field Programmable Gate Array (FPGA), and so on, and part or all of the functional blocks may be implemented by the hardware. For example, the processor 1001 may be implemented with at least one of these pieces of hardware.

### Variations

Note that the terminology described in the present disclosure and the terminology that is needed to understand the present disclosure may be replaced by other terms that convey the same or similar meanings. For example, a “channel,” a “symbol,” and a “signal” (or signaling) may be used interchangeably. Also, “signals” may be “messages.” A reference signal may be abbreviated as an “RS,” and may be referred to as a “pilot,” a “pilot signal,”and so on, depending on which standard applies. Furthermore, a “component carrier (CC)” may be referred to as a “cell,”a “frequency carrier,”a “carrier frequency”and so on.

A radio frame may be constituted of one or a plurality of periods (frames) in the time domain. Each of one or a plurality of periods (frames) constituting a radio frame may be referred to as a “subframe.” Furthermore, a subframe may be constituted of one or a plurality of slots in the time domain. A subframe may be a fixed time length (for example, 1 ms) independent of numerology.

Here, numerology may be a communication parameter applied to at least one of transmission and reception of a given signal or channel. For example, numerology may indicate at least one of a subcarrier spacing (SCS), a bandwidth, a symbol length, a cyclic prefix length, a transmission time interval (TTI), the number of symbols per TTI, a radio frame structure, a particular filter processing performed by a transceiver in the frequency domain, a particular windowing processing performed by a transceiver in the time domain, and so on.

A slot may be constituted of one or a plurality of symbols in the time domain (Orthogonal Frequency Division Multiplexing (OFDM) symbols, Single Carrier Frequency Division Multiple Access (SC-FDMA) symbols, and so on). Furthermore, a slot may be a time unit based on numerology.

A slot may include a plurality of mini-slots. Each mini-slot may be constituted of one or a plurality of symbols in the time domain. A mini-slot may be referred to as a “sub-slot.” A mini-slot may be constituted of symbols less than the number of slots. A PDSCH (or PUSCH) transmitted in a time unit larger than a mini-slot may be referred to as “PDSCH (PUSCH) mapping type A.” A PDSCH (or PUSCH) transmitted using a mini-slot may be referred to as “PDSCH (PUSCH) mapping type B.”

A radio frame, a subframe, a slot, a mini-slot, and a symbol all express time units in signal communication. A radio frame, a subframe, a slot, a mini-slot, and a symbol may each be called by other applicable terms. Note that time units such as a frame, a subframe, a slot, mini-slot, and a symbol in the present disclosure may be used interchangeably.

For example, one subframe may be referred to as a “TTI,” a plurality of consecutive subframes may be referred to as a “TTI,” or one slot or one mini-slot may be referred to as a “TTI.” That is, at least one of a subframe and a TTI may be a subframe (1 ms) in existing LTE, may be a shorter period than 1 ms (for example, 1 to 13 symbols), or may be a longer period than 1 ms. Note that a unit expressing TTI may be referred to as a “slot,” a “mini-slot, ” and so on instead of a “subframe.”

Here, a TTI refers to the minimum time unit of scheduling in radio communication, for example. For example, in LTE systems, a base station schedules the allocation of radio resources (such as a frequency bandwidth and transmit power that are available for each user terminal) for the user terminal in TTI units. Note that the definition of TTIs is not limited to this.

TTIs may be transmission time units for channel-encoded data packets (transport blocks), code blocks, or codewords, or may be the unit of processing in scheduling, link adaptation, and so on. Note that, when TTIs are given, the time interval (for example, the number of symbols) to which transport blocks, code blocks, codewords, or the like are actually mapped may be shorter than the TTIS.

Note that, in the case where one slot or one mini-slot is referred to as a TTI, one or more TTIs (that is, one or more slots or one or more mini-slots) may be the minimum time unit of scheduling. Furthermore, the number of slots (the number of mini-slots) constituting the minimum time unit of the scheduling may be controlled.

A TTI having a time length of 1 ms may be referred to as a “normal TTI” (TTI in 3GPP Rel. 8 to Rel. 12), a “long TTI,” a “normal subframe,” a “long subframe,” a “slot” and so on. A TTI that is shorter than a normal TTI may be referred to as a “shortened TTI,” a “short TTI,” a “partial or fractional TTI,” a “shortened subframe,” a “short subframe,” a “mini-slot,” a “sub-slot,” a “slot” and so on.

Note that a long TTI (for example, a normal TTI, a subframe, and so on) may be interpreted as a TTI having a time length exceeding 1 ms, and a short TTI (for example, a shortened TTI and so on) may be interpreted as a TTI having a TTI length shorter than the TTI length of a long TTI and equal to or longer than 1 ms.

A resource block (RB) is the unit of resource allocation in the time domain and the frequency domain, and may include one or a plurality of consecutive subcarriers in the frequency domain. The number of subcarriers included in an RB may be the same regardless of numerology, and, for example, may be 12. The number of subcarriers included in an RB may be determined based on numerology.

Also, an RB may include one or a plurality of symbols in the time domain, and may be one slot, one mini-slot, one subframe, or one TTI in length. One TTI, one subframe, and so on each may be constituted of one or a plurality of resource blocks.

Note that one or a plurality of RBs may be referred to as a “physical resource block (Physical RB (PRB) ),” a “sub-carrier group (SCG),” a “resource element group (REG),”a “PRB pair,” an “RB pair” and so on.

Furthermore, a resource block may be constituted of one or a plurality of resource elements (REs). For example, one RE may correspond to a radio resource field of one subcarrier and one symbol.

A bandwidth part (BWP) (which may be referred to as a “fractional bandwidth,” and so on) may represent a subset of contiguous common resource blocks (common RBs) for certain numerology in a certain carrier. Here, a common RB may be specified by an index of the RB based on the common reference point of the carrier. A PRB may be defined by a certain BWP and may be numbered in the BWP.

The BWP may include a UL BWP (BWP for the UL) and a DL BWP (BWP for the DL). One or a plurality of BWPs may be configured in one carrier for a UE.

At least one of configured BWPs may be active, and a UE does not need to assume to transmit/receive a given signal/channel outside active BWPs. Note that a “cell,” a “carrier,” and so on in the present disclosure may be interpreted as a “BWP”.

Note that the above-described structures of radio frames, subframes, slots, mini-slots, symbols, and so on are merely examples. For example, structures such as the number of subframes included in a radio frame, the number of slots per subframe or radio frame, the number of mini-slots included in a slot, the numbers of symbols and RBs included in a slot or a mini-slot, the number of subcarriers included in an RB, the number of symbols in a TTI, the symbol length, the cyclic prefix (CP) length, and so on can be variously changed.

Also, the information, parameters, and so on described in the present disclosure may be represented in absolute values or in relative values with respect to given values, or may be represented in another corresponding information. For example, radio resources may be indicatedby given indices.

The names used for parameters and so on in the present disclosure are in no respect limiting. Furthermore, mathematical expressions that use these parameters, and so on may be different from those expressly disclosed in the present disclosure. For example, since various channels (PUCCH, PDCCH, and so on) and information elements can be identified by any suitable names, the various names allocated to these various channels and information elements are in no respect limiting.

The information, signals, and so on described in the present disclosure may be represented by using any of a variety of different technologies. For example, data, instructions, commands, information, signals, bits, symbols, chips, and so on, all of which may be referenced throughout the herein-contained description, may be represented by voltages, currents, electromagnetic waves, magnetic fields or particles, optical fields or photons, or any combination of these.

Also, information, signals, and so on can be output in at least one of from higher layers to lower layers and from lower layers to higher layers. Information, signals, and so on may be input and/or output via a plurality of network nodes.

The information, signals, and so on that are input and/or output may be stored in a specific location (for example, a memory) or may be managed by using a management table. The information, signals, and so on to be input and/or output can be overwritten, updated, or appended. The information, signals, and so on that are output may be deleted. The information, signals, and so on that are input may be transmitted to another apparatus.

Reporting of information is by no means limited to the aspects/embodiments described in the present disclosure, and other methods may be used as well. For example, reporting of information in the present disclosure may be implemented by using physical layer signaling (for example, downlink control information (DCI), uplink control information (UCI) ), higher layer signaling (for example, Radio Resource Control (RRC) signaling, broadcast information (master information block (MIB), system information blocks (SIBs), and so on), Medium Access Control (MAC) signaling and so on), and other signals or combinations of these.

Note that physical layer signaling may be referred to as “Layer 1/Layer 2 (L1/L2) control information (L1/L2 control signals),” “L1 control information (L1 control signal),” and so on. Also, RRC signaling may be referred to as an “RRC message,” and can be, for example, an RRC connection setup message, an RRC connection reconfiguration message, and so on. Also, MAC signaling may be reported using, for example, MAC control elements (MAC CES).

Also, reporting of given information (for example, reporting of “X holds”) does not necessarily have to be reported explicitly, and can be reported implicitly (by, for example, not reporting this given information or reporting another piece of information).

Determinations may be made in values represented by one bit (0 or 1), may be made in Boolean values that represent true or false, or may be made by comparing numerical values (for example, comparison against a given value).

Software, whether referred to as “software,” “firmware,” “middleware,” “microcode,” or “hardware description language,” or called by other terms, should be interpreted broadly to mean instructions, instruction sets, code, code segments, program codes, programs, subprograms, software modules, applications, software applications, software packages, routines, subroutines, objects, executable files, execution threads, procedures, functions, and so on.

Also, software, commands, information, and so on may be transmitted and received via communication media. For example, when software is transmitted from a website, a server, or other remote sources by using at least one of wired technologies (coaxial cables, optical fiber cables, twisted-pair cables, digital subscriber lines (DSL), and so on) and wireless technologies (infrared radiation, microwaves, and so on), at least one of these wired technologies and wireless technologies are also included in the definition of communication media.

The terms “system” and “network” used in the present disclosure can be used interchangeably. The “network” may mean an apparatus (for example, a base station) included in the network.

In the present disclosure, the terms such as “precoding,” a “precoder,” a “weight (precoding weight),” “quasi-co-location (QCL),” a “Transmission Configuration Indication state (TCI state),” a “spatial relation,” a “spatial domain filter,” a “transmit power,” “phase rotation,” an “antenna port,” an “antenna port group,” a “layer,” “the number of layers,” a “rank,” a “resource,” a “resource set,” a “resource group,” a “beam,” a “beam width,” a “beam angular degree,” an “antenna,” an “antenna element,” a “panel,” and so on can be used interchangeably.

In the present disclosure, the terms such as a “base station (BS),” a “radio base station,” a “fixed station,” a “NodeB,” an “eNB (eNodeB),” a “gNB (gNodeB),” an “access point,” a “transmission point (TP),” a “reception point (RP),” a “transmission/reception point (TRP),” a “panel,” a “cell,” a “sector,” a “cell group,” a “carrier,” a “component carrier,” and so on can be used interchangeably. The base station may be referred to as the terms such as a “macro cell,” a “small cell,” a “femto cell,”a “pico cell,”and so on.

A base station can accommodate one or a plurality of (for example, three) cells. When a base station accommodates a plurality of cells, the entire coverage area of the base station can be partitioned into multiple smaller areas, and each smaller area can provide communication services through base station subsystems (for example, indoor small base stations (Remote Radio Heads (RRHs))). The term “cell” or “sector” refers to part of or the entire coverage area of at least one of a base station and a base station subsystem that provides communication services within this coverage.

In the present disclosure, a case that a base station transmits information to a terminal may be interpreted as a case that the base station indicates, for the terminal, control/operation based on the information, and vice versa.

In the present disclosure, the terms “mobile station (MS),” “user terminal,” “user equipment (UE),” and “terminal” may be used interchangeably.

A mobile station may be referred to as a “subscriber station,” “mobile unit,” “subscriber unit,” “wireless unit,” “remote unit,” “mobile device,” “wireless device,” “wireless communication device,” “remote device,” “mobile subscriber station,” “access terminal,” “mobile terminal,” “wireless terminal,” “remote terminal,” “handset,” “user agent,” “mobile client,” “client,” or some other appropriate terms in some cases.

At least one of a base station and a mobile station may be referred to as a “transmitting apparatus,” a “receiving apparatus,” a “radio communication apparatus,” and so on. Note that at least one of a base station and a mobile station may be a device mounted on a moving object or a moving object itself, and so on.

The moving object is a movable object with any moving speed, and naturally a case where the moving object is stopped is also included. Examples of the moving object include a vehicle, a transport vehicle, an automobile, a motorcycle, a bicycle, a connected car, a loading shovel, a bulldozer, a wheel loader, a dump truck, a fork lift, a train, a bus, a trolley, a rickshaw, a ship and other watercraft, an airplane, a rocket, an artificial satellite, a drone, a multicopter, a quadcopter, a balloon, and an object mounted on any of these, but these are not restrictive. The moving object may be a moving object that autonomously travels based on a direction for moving.

The moving object may be a vehicle (for example, a car, an airplane, and the like), may be a moving object which moves unmanned (for example, a drone, an autonomous car, and the like), or may be a robot (a manned type or unmanned type). Note that at least one of a base station and a mobile station also includes an apparatus which does not necessarily move during communication operation. For example, at least one of a base station and a mobile station may be an Internet of Things (IoT) device such as a sensor.

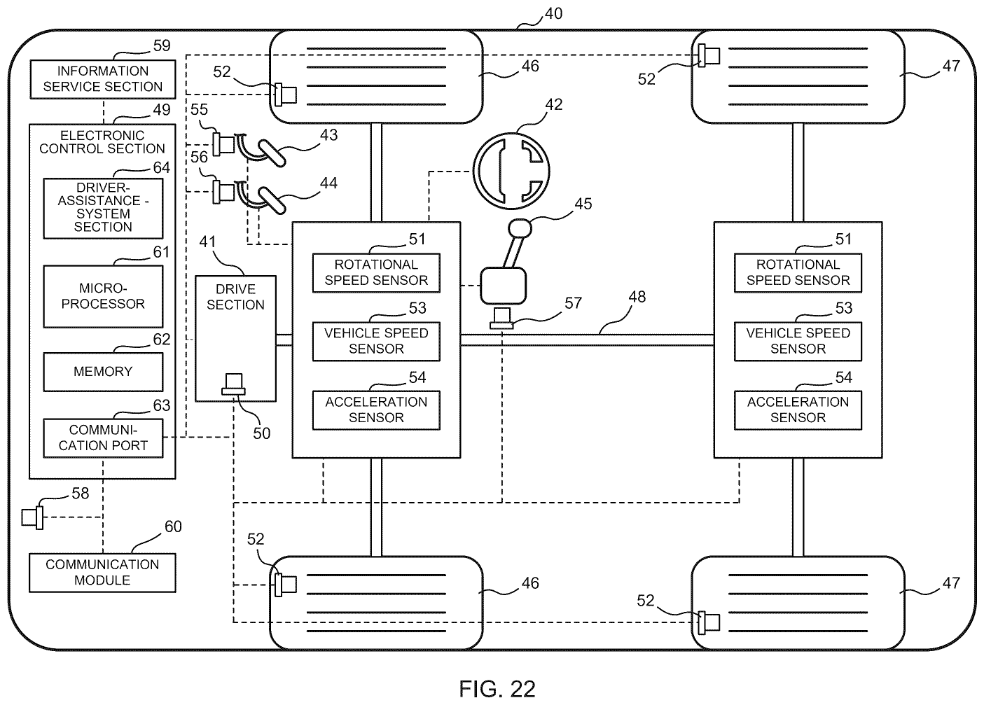

FIG. 22 is a diagram to show an example of a vehicle according to one embodiment. A vehicle 40 includes a drive section 41, a steering section 42, an accelerator pedal 43, a brake pedal 44, a shift lever 45, right and left front wheels 46, right and left rear wheels 47, an axle 48, an electronic control section 49, various sensors (including a current sensor 50, a rotational speed sensor 51, a pneumatic sensor 52, a vehicle speed sensor 53, an acceleration sensor 54, an accelerator pedal sensor 55, a brake pedal sensor 56, a shift lever sensor 57, and an object detection sensor 58), an information service section 59, and a communication module 60.

The drive section 41 includes, for example, at least one of an engine, a motor, and a hybrid of an engine and a motor. The steering section 42 at least includes a steering wheel, and is configured to steer at least one of the front wheels 46 and the rear wheels 47, based on operation of the steering wheel operated by a user.

The electronic control section 49 includes a microprocessor 61, a memory (ROM, RAM) 62, and a communication port (for example, an input/output (IO) port) 63. The electronic control section 49 receives, as input, signals from the various sensors 50 to 58 included in the vehicle. The electronic control section 49 may be referred to as an Electronic Control Unit (ECU).

Examples of the signals from the various sensors 50 to 58 include a current signal from the current sensor 50 for sensing current of a motor, a rotational speed signal of the front wheels 46/rear wheels 47 acquired by the rotational speed sensor 51, a pneumatic signal of the front wheels 46/rear wheels 47 acquired by the pneumatic sensor 52, a vehicle speed signal acquired by the vehicle speed sensor 53, an acceleration signal acquired by the acceleration sensor 54, a depressing amount signal of the accelerator pedal 43 acquired by the accelerator pedal sensor 55, a depressing amount signal of the brake pedal 44 acquired by the brake pedal sensor 56, an operation signal of the shift lever 45 acquired by the shift lever sensor 57, and a detection signal for detecting an obstruction, a vehicle, a pedestrian, and the like acquired by the object detection sensor 58.

The information service section 59 includes various devices for providing (outputting) various pieces of information such as drive information, traffic information, and entertainment information, such as a car navigation system, an audio system, a speaker, a display, a television, and a radio, and one or more ECUs that control these devices. The information service section 59 provides various pieces of information/services (for example, multimedia information/multimedia service) for an occupant of the vehicle 40, using information acquired from an external apparatus via the communication module 60 and the like.

The information service section 59 may include an input device (for example, a keyboard, a mouse, a microphone, a switch, a button, a sensor, a touch panel, and the like) for receiving input from the outside, or may include an output device (for example, a display, a speaker, an LED lamp, a touch panel, and the like) for implementing output to the outside.

A driver-assistance-system section 64 includes various devices for providing functions for preventing an accident and reducing a driver's driving load, such as a millimeter wave radar, Light Detection and Ranging (LiDAR), a camera, a positioning locator (for example, a Global Navigation Satellite System (GNSS) and the like), map information (for example, a high definition (HD) map, an autonomous vehicle (AV) map, and the like), a gyro system (for example, an inertial measurement apparatus (inertial measurement unit (IMU)), an inertial navigation apparatus (inertial navigation system (INS)), and the like), an artificial intelligence (AI) chip, and an AI processor, and one or more ECUs that control these devices. The driver-assistance-system section 64 transmits and receives various pieces of information via the communication module 60, and implements a driving assistance function or an autonomous driving function.

The communication module 60 can communicate with the microprocessor 61 and the constituent elements of the vehicle 40 via the communication port 63. For example, via the communication port 63, the communication module 60 transmits and receives data (information) to and from the drive section 41, the steering section 42, the accelerator pedal 43, the brake pedal 44, the shift lever 45, the right and left front wheels 46, the right and left rear wheels 47, the axle 48, the microprocessor 61 and the memory (ROM, RAM) 62 in the electronic control section 49, and the various sensors 50 to 58, which are included in the vehicle 40.

The communication module 60 can be controlled by the microprocessor 61 of the electronic control section 49, and is a communication device that can perform communication with an external apparatus. For example, the communication module 60 performs transmission and reception of various pieces of information to and from the external apparatus via radio communication. The communication module 60 may be either inside or outside the electronic control section 49. The external apparatus may be, for example, the base station 10, the user terminal 20, or the like described above. The communication module 60 may be, for example, at least one of the base station 10 and the user terminal 20 described above (may function as at least one of the base station 10 and the user terminal 20).

The communication module 60 may transmit at least one of signals from the various sensors 50 to 58 described above input to the electronic control section 49, information obtained based on the signals, and information based on an input from the outside (a user) obtained via the information service section 59, to the external apparatus via radio communication. The electronic control section 49, the various sensors 50 to 58, the information service section 59, and the like may be referred to as input sections that receive input. For example, the PUSCH transmitted by the communication module 60 may include information based on the input.

The communication module 60 receives various pieces of information (traffic information, signal information, inter-vehicle distance information, and the like) transmitted from the external apparatus, and displays the various pieces of information on the information service section 59 included in the vehicle. The information service section 59 may be referred to as an output section that outputs information (for example, outputs information to devices, such as a display and a speaker, based on the PDSCH received by the communication module 60 (or data/information decoded from the PDSCH) ).

The communication module 60 stores the various pieces of information received from the external apparatus in the memory 62 that can be used by the microprocessor 61. Based on the pieces of information stored in the memory 62, the microprocessor 61 may perform control of the drive section 41, the steering section 42, the accelerator pedal 43, the brake pedal 44, the shift lever 45, the right and left front wheels 46, the right and left rear wheels 47, the axle 48, the various sensors 50 to 58, and the like included in the vehicle 40.

Furthermore, the base station in the present disclosure may be interpreted as a user terminal. For example, each aspect/embodiment of the present disclosure may be applied to the structure that replaces a communication between a base station and a user terminal with a communication between a plurality of user terminals (for example, which may be referred to as “Device-to-Device (D2D) ,” “Vehicle-to-Everything (V2X),” and the like). In this case, user terminals 20 may have the functions of the base stations 10 described above. The words such as “uplink” and “downlink” may be interpreted as the words corresponding to the terminal-to-terminal communication (for example, “sidelink”). For example, an uplink channel, a downlink channel and so on may be interpreted as a sidelink channel.

Likewise, the user terminal in the present disclosure may be interpreted as base station. In this case, the base station 10 may have the functions of the user terminal 20 described above.

Actions which have been described in the present disclosure to be performed by a base station may, in some cases, be performed by upper nodes of the base station. In a network including one or a plurality of network nodes with base stations, it is clear that various operations that are performed to communicate with terminals can be performed by base stations, one or more network nodes (for example, Mobility Management Entities (MMEs), Serving-Gateways (S-GWs), and so on may be possible, but these are not limiting) other than base stations, or combinations of these.

The aspects/embodiments illustrated in the present disclosure may be used individually or in combinations, which may be switched depending on the mode of implementation. The order of processes, sequences, flowcharts, and so on that have been used to describe the aspects/embodiments in the present disclosure may be re-ordered as long as inconsistencies do not arise. For example, although various methods have been illustrated in the present disclosure with various components of steps in exemplary orders, the specific orders that are illustrated herein are by no means limiting.

The aspects/embodiments illustrated in the present disclosure may be applied to Long Term Evolution (LTE), LTE-Advanced (LTE-A), LTE-Beyond (LTE-B), SUPER 3G, IMT-Advanced, 4th generation mobile communication system (4G), 5th generation mobile communication system (5G), 6th generation mobile communication system (6G), xth generation mobile communication system (xG (where x is, for example, an integer or a decimal) ), Future Radio Access (FRA), New-Radio Access Technology (RAT), New Radio (NR), New radio access (NX), Future generation radio access (FX), Global System for Mobile communications (GSM (registered trademark) ), CDMA 2000, Ultra Mobile Broadband (UMB), IEEE 802.11 (Wi-Fi (registered trademark) ), IEEE 802.16 (WiMAX (registered trademark) ), IEEE 802.20, Ultra-WideBand (UWB), Bluetooth (registered trademark), systems that use other adequate radio communication methods and next-generation systems that are enhanced, modified, created, or defined based on these. A plurality of systems may be combined (for example, a combination of LTE or LTE-A and 5G, and the like) and applied.

The phrase “based on” (or “on the basis of”) as used in the present disclosure does not mean “based only on” (or “only on the basis of”), unless otherwise specified. In other words, the phrase “based on” (or “on the basis of”) means both “based only on” and “based at least on” (“only on the basis of” and “at least on the basis of”).

Reference to elements with designations such as “first,” “second,” and so on as used in the present disclosure does not generally limit the quantity or order of these elements. These designations may be used in the present disclosure only for convenience, as a method for distinguishing between two or more elements. Thus, reference to the first and second elements does not imply that only two elements may be employed, or that the first element must precede the second element in some way.

The term “judging (determining) ” as in the present disclosure herein may encompass a wide variety of actions. For example, “judging (determining)” may be interpreted to mean making “judgments (determinations)” about judging, calculating, computing, processing, deriving, investigating, looking up, search and inquiry (for example, searching a table, a database, or some other data structures), ascertaining, and so on.

Furthermore, “judging (determining)” may be interpreted to mean making “judgments (determinations)” about receiving (for example, receiving information), transmitting (for example, transmitting information), input, output, accessing (for example, accessing data in a memory), and so on.

In addition, “judging (determining)” as used herein may be interpreted to mean making “judgments (determinations)” about resolving, selecting, choosing, establishing, comparing, and so on. In other words, “judging (determining)” may be interpreted to mean making “judgments (determinations)” about some action.

In addition, “judging (determining)” may be interpreted as “assuming,”“expecting,” “considering,” and the like.

“The maximum transmit power” according to the present disclosure may mean a maximum value of the transmit power, may mean the nominal maximum transmit power (the nominal UE maximum transmit power), or may mean the rated maximum transmit power (the rated UE maximum transmit power).

The terms “connected” and “coupled,” or any variation of these terms as used in the present disclosure mean all direct or indirect connections or coupling between two or more elements, and may include the presence of one or more intermediate elements between two elements that are “connected” or “coupled” to each other. The coupling or connection between the elements may be physical, logical, or a combination thereof. For example, “connection” may be interpreted as “access.”

In the present disclosure, when two elements are connected, the two elements may be considered “connected” or “coupled” to each other by using one or more electrical wires, cables and printed electrical connections, and, as some non-limiting and non-inclusive examples, by using electromagnetic energy having wavelengths in radio frequency regions, microwave regions, (both visible and invisible) optical regions, or the like.

In the present disclosure, the phrase “A and B are different” may mean that “A and B are different from each other.” Note that the phrase may mean that “A and B are each different from C.” The terms “separate,” “be coupled,” and so on may be interpreted similarly to “different.”

When terms such as “include,” “including,” and variations of these are used in the present disclosure, these terms are intended to be inclusive, in a manner similar to the way the term “comprising” is used. Furthermore, the term “or” as used in the present disclosure is intended to be not an exclusive disjunction.

For example, in the present disclosure, when an article such as “a,” “an,” and “the” in the English language is added by translation, the present disclosure may include that a noun after these articles is in a plural form.

In the Present Disclosure, “equal to or Smaller Than,”“smaller than,” “equal to or larger than,” “larger than,” “equal to,” and the like may be interchangeably interpreted. In the present disclosure, words such as “good,” “poor,” “large,” “small,” “high,” “low,” “early,” “late,” “wide,” “narrow,” and the like may be interchangeably interpreted irrespective of positive degree, comparative degree, and superlative degree. In the present disclosure, expressions obtained by adding “i-th” (i is any integer) to words such as “good,” “poor,” “large,” “small,” “high,” “low,” “early,” “late,” “wide,” “narrow,” and the like may be interchangeably interpreted irrespective of positive degree, comparative degree, and superlative degree (for example, “highest” may be interpreted as “i-th highest,”and vice versa).

In the present disclosure, “of,” “for,” “regarding,” “related to,” “associated with,” and the like may be interchangeably interpreted.

Now, Although the Invention According to the Present disclosure has been described in detail above, it should be obvious to a person skilled in the art that the invention according to the present disclosure is by no means limited to the embodiments described in the present disclosure. The invention according to the present disclosure can be implemented with various corrections and in various modifications, without departing from the spirit and scope of the invention defined by the recitations of claims. Consequently, the description of the present disclosure is provided only for the purpose of explaining examples, and should by no means be construed to limit the invention according to the present disclosure in any way.

1-6. (canceled)

7. A terminal comprising:
a processor that determines respective resources for a plurality of repetitions of a physical random access channel (PRACH); and
a transmitter that transmits each of the plurality of repetitions, using the respective resources,
wherein the processor supports a separate random access channel (RACH) configuration for each of the plurality of repetitions of the PRACH according to different repetition numbers configured for the plurality of repetitions.

8. The terminal according to claim 7, wherein the processor supports a separate RACH configuration index for each of the plurality of repetitions of the PRACH according to the different repetition numbers configured for the plurality of repetitions.

9. The terminal according to claim 7, wherein the respective resources are random access channel occasions.

10. The terminal according to claim 9, wherein the processor determines, based on the respective RACH configuration, the random access channel occasions for each of the plurality of repetitions.

11. The terminal according to claim 7, wherein the processor supports 2 and 4 as the different repetition numbers.

12. A radio communication method for a terminal, comprising:
determining respective resources for a plurality of repetitions of a physical random access channel (PRACH); and
transmitting each of the plurality of repetitions, using the respective resources,
wherein a separate random access channel (RACH) configuration is supported for each of the plurality of repetitions of the PRACH according to different repetition numbers configured for the plurality of repetitions.

13. A base station comprising:
a processor that controls transmission of a configuration for determining respective resources for a plurality of repetitions of a physical random access channel (PRACH); and
a receiver that receives at least one of the plurality of repetitions, using at least one of the respective resources,
wherein a separate random access channel (RACH) configuration is supported for each of the plurality of repetitions of the PRACH according to different repetition numbers in the transmitted configuration.

14. A system comprising a terminal and a base station, wherein the terminal comprises:
a processor that determines respective resources for a plurality of repetitions of a physical random access channel (PRACH); and
a transmitter that transmits each of the plurality of repetitions, using the respective resources,
wherein the processor supports a separate random access channel (RACH) configuration for each of the plurality of repetitions of the PRACH according to different repetition numbers configured for the plurality of repetitions, and the base station comprises:
a processor that controls transmission of a configuration for determining the respective resources; and
a receiver that receives at least one of the plurality of repetitions.
